(19) United States
(12) Patent Application Publication
(10) Pub. No.: US 2023/0323031 A1
(43) Pub. Date: Oct. 12, 2023

(54) POLYMER COMPRISING A PLURALITY OF ACTIVE AMINE GROUPS, RELATED POLYMERS AND RELATED METHODS THEREOF

(71) Applicant: Agency for Science, Technology and Research, Singapore (SG)

(72) Inventors: Satyasankar Jana, Singapore (SG); Jayasree Seayad, Singapore (SG); Abdul Majeed Seayad, Singapore (SG); Ping Sen Choong, Singapore (SG)

(21) Appl. No.: 18/044,268

(22) PCT Filed: Oct. 21, 2021
(86) PCT No.: PCT/SG2021/050640

§ 371 Date: Mar. 7, 2023

(30) Foreign Application Priority Data
Oct. 26, 2020 (SG) 10202010612S

(51) Int. Cl. C08G 71/04; C11D 11/00; C11D 3/00; C11D 3/37; C10M 149/14; A01N 47/12; A01P 1/00; B01D 53/62; B01D 53/78; B01D 53/14

(52) U.S. Cl. CPC C08G 71/04; C11D 11/0017; C11D 3/0036; C11D 3/3726; C10M 149/14; A01N 47/12; A01P 1/00; B01D 53/62; B01D 53/78; B01D 53/1475; B01D 53/1493; C08G 2230/00; C10M 2217/045; B01D 2252/20415; B01D 2257/504

(57) ABSTRACT

There is provided a polymer or derivative thereof comprising a plurality of active amine groups in the backbone, wherein the polymer is a reaction product of a reaction between one or more bis-carbonates and one or more amine compounds having at least two terminal amino groups. Also provided are use of the polymer or derivative thereof and a method of preparing the polymer or derivative thereof.

### TECHNICAL FIELD

The present disclosure relates broadly to a polymer comprising a plurality of active amine groups in the backbone of the polymer, a derivative thereof and use of said polymer. The present disclosure also relates to methods of preparing said polymer and a derivative thereof.

### BACKGROUND

There is increasing demand for amine containing polymers in a wide range of applications such as in the chemicals, pharmaceuticals, cosmetics, consumer and personal care industries.

However, the search for a suitable amine containing polymer is often challenging.

This is because amine polymers have several limitations and are far from desirable. This is further elaborated below.

Amine polymers often lack biocompatibility and biodegradability. There are also very few amine polymers that are soluble in water. One of the most commercially utilized amine polymer is polyethylene imine (PEI). Particularly, the branched form of PEI is commonly used due to its unique structure of having all primary, secondary and tertiary amine groups, which makes PEI a strong metal chelating and highly interacting polymer. However, there are concerns over its cytotoxicity (mainly due to the plurality of —NH₂ group). Attempts have been made to reduce/avoid cytotoxicity of PEI. For example, modifications have been made on PEI with either polyethylene glycol (PEG) groups or subjecting PEI to ethoxylation. However, such modified polymers are still far from desirable as they still lack biocompatibility and biodegradability.

In view of the above, there is a need to address or at least ameliorate the above-mentioned problems. In particular, there is a need to provide a polymer comprising a plurality of active amine groups in the backbone of the polymer, a derivative of and related methods that address or at least ameliorate the above-mentioned problems.

### SUMMARY

In one aspect, there is provided a polymer or derivative thereof comprising a plurality of active amine groups in the backbone, wherein the polymer is a reaction product of a reaction between one or more bis-carbonates and one or more amine compounds having at least two terminal amino groups.

In one embodiment, the polymer is a bio-based polymer and at least one of the bis-carbonates and/or at least one of the amine compounds having at least two terminal amino groups is derived from a bio-based source.

In one embodiment, the content of the polymer derived from a bio-based source ranges from 30% to 90% by weight of the polymer.

In one embodiment, the plurality of active amine groups comprise a plurality of different amine functionalities.

In one embodiment, the one or more amine compounds having at least two terminal amino groups are represented by general formula (1) and the one or more bis-carbonates are represented by general formula (2):

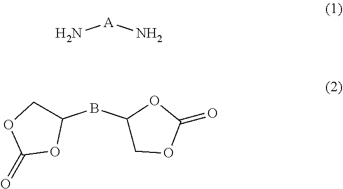

wherein
A comprises a linear aliphatic, branched aliphatic, cyclic and/or aromatic hydrocarbons comprising at least one active amine group; and
B comprises a linear aliphatic, branched aliphatic, cyclic and/or aromatic hydrocarbons that optionally comprises at least one of an ether, amine, ester and combinations thereof.

In one embodiment, the polymer comprises one or more structural units represented by general formula (3), one or more structural units represented by general formula (4):

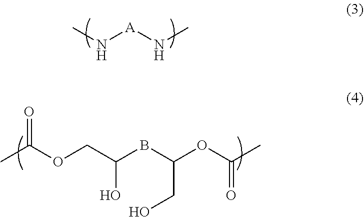

wherein
A comprises a linear aliphatic, branched aliphatic, cyclic and/or aromatic hydrocarbons comprising at least one active amine group; and
B comprises a linear aliphatic, branched aliphatic, cyclic and/or aromatic hydrocarbons that optionally comprises at least one of an ether, amine, ester or combinations thereof.

In one embodiment, the structural units represented by general formula (3) are linked to structural units represented by general formula (4) via carbamate/urethane linkages.

In one embodiment, A is selected from the following general formula (5), (6), (7) or (8):

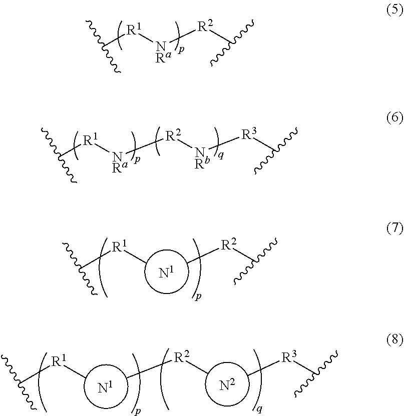

wherein
R¹, R² and R³ are each independently selected from a single bond, optionally substituted alkyl, optionally substituted alkenyl, optionally substituted alkynyl, optionally substituted cycloalkyl or optionally substituted cycloalkenyl;
R^{a} and R^{b} are each independently selected from the group consisting of H, optionally substituted alkyl, optionally substituted alkenyl and optionally substituted alkynyl;
ring N¹ and N² are each independently an optionally substituted 5-membered or 6-membered nitrogen-containing cyclic ring;
p≥1; and q≥0.

In one embodiment, ring N¹ and N² are each independently selected from the group consisting of 3-pyrroline, 2-pyrroline, 2H-pyrrole, 1H-pyrrole, 2-pyrazoline, 2-imidazoline, pyrazole, imidazole, 1,2,4-triazole, 1,2,3-triazole, oxazole, isoxazole, isothiazole, thiazole, 1,2,5-oxadiazole, 1,2,3-oxadizole, 1,3,4-thiadiazole, 1,2,5-thiadiazole, diphenylamine, pyridine, pyridazine, pyrimidine, pyrazine, 1,2,4-triazine, 1,3,5-triazine, oxazine, thiazine, pyrazolidine, imidazolidine, piperidine, N-methylpiperidine, N-phenylpiperidine, pyrrolidine, piperazine, morpholine, thiomorpholine, 1,4-diazepane, quinoline, acridine and combinations thereof.

In one embodiment, B is selected from the following general formula (9), (10) or (11):

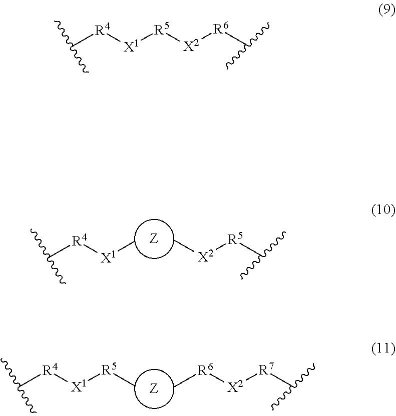

wherein
R⁴, R⁵, R⁶ and R⁷ are each independently selected from a single bond, optionally substituted alkyl, optionally substituted alkenyl, optionally substituted alkynyl, optionally substituted cycloalkyl or optionally substituted cycloalkenyl;
X¹ and X² are each independently selected from the group consisting of a single bond, —O—, —NR^{c}—, —C(═O)—O— and —O—C(═O)—, wherein R^{c} is selected from the group consisting of H, optionally substituted alkyl, optionally substituted alkenyl and optionally substituted alkynyl; and
ring Z is an optionally substituted 5-membered or 6-membered hydrocarbon cyclic ring or an optionally substituted 5-membered or 6-membered heterocyclic ring having up to three heteroatoms independently selected from the group consisting of O, N, S and NH.

In one embodiment, R¹ to R⁷ are each independently selected from a single bond, optionally substituted C₁-C₂₀ alkyl, C₁-C₂₀ optionally substituted alkenyl, C₁-C₂₀ optionally substituted alkynyl, C₁-C₂₀ optionally substituted cycloalkyl and C₁-C₂₀ optionally substituted cycloalkenyl; and R^{a} and R^{b} are each independently selected from the group consisting of H, optionally substituted C₁-C₂₀ alkyl, optionally substituted C₁-C₂₀ alkenyl and optionally substituted C₁-C₂₀ alkynyl.

In one embodiment, the one or more amine compounds having at least two terminal amino groups are selected from the group consisting of diethylenetriamine (DETA), diamino-N-methyldiethylamine (DMA), triethylenetetramine (TETA), diamino-N-methyldipropylamine (DMPA), pentaethylenehexamine (PEHA), bis(3-aminopropyl)piperazine (BAP), spermine, spermidine, lysine salt (LyS) and diaminopentane (DAP):

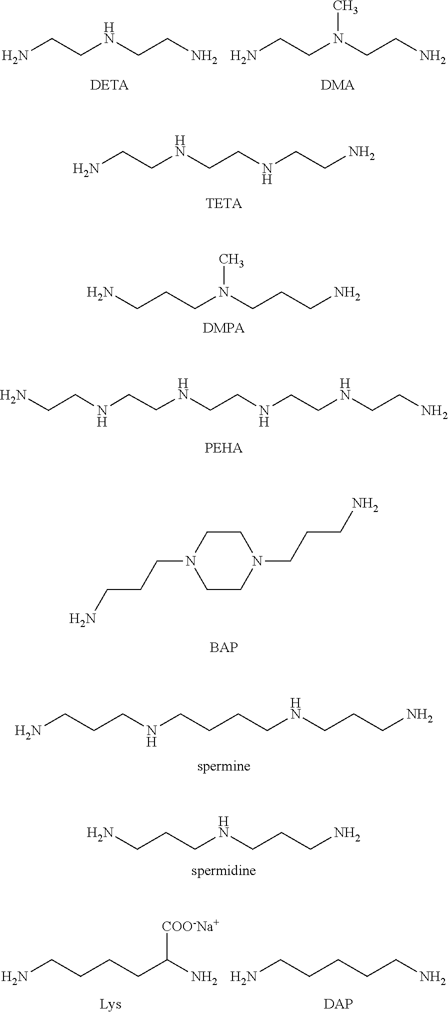

In one embodiment, the one or more bis-carbonates are selected from the group consisting of succinic bis-carbonate (SuBC), adipic bis-carbonate (ABC), butanediol bis-carbonate (BBC), isomers of pyridine bis-carbonate (PBC1), (PBC2), (PBC3), (PBC4), (PBC5) and/or (PBC6):

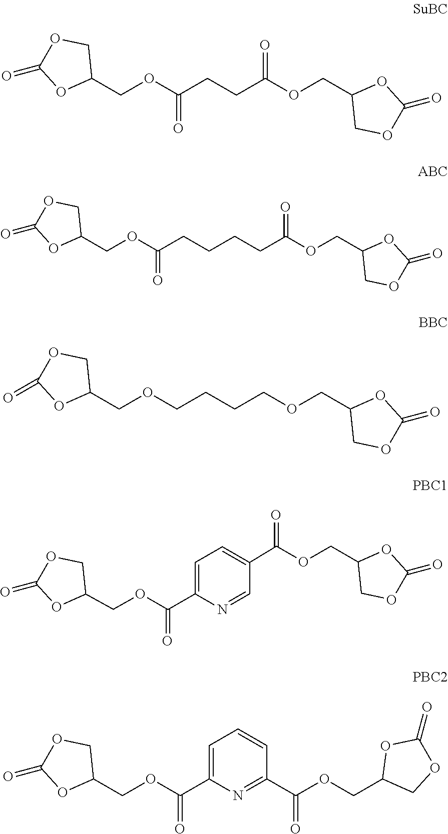 [SMILES: O=C(CCC(=O)OCC1COC(=O)O1)OCC1COC(=O)O1 ; O=C(CCCCC(=O)OCC1COC(=O)O1)OCC1COC(=O)O1 ; O=C1OCC(COCCCCOCC2COC(=O)O2)O1 ; O=C1OCC(COC(=O)c2ccc(C(=O)OCC3COC(=O)O3)nc2)O1 ; O=C1OCC(COC(=O)c2cccc(C(=O)OCC3COC(=O)O3)n2)O1]

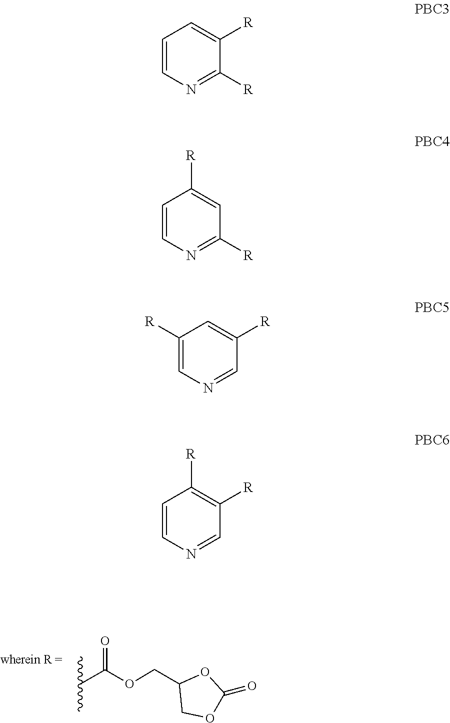

In one embodiment, the polymer or derivative of any one of the preceding claims selected from the following:

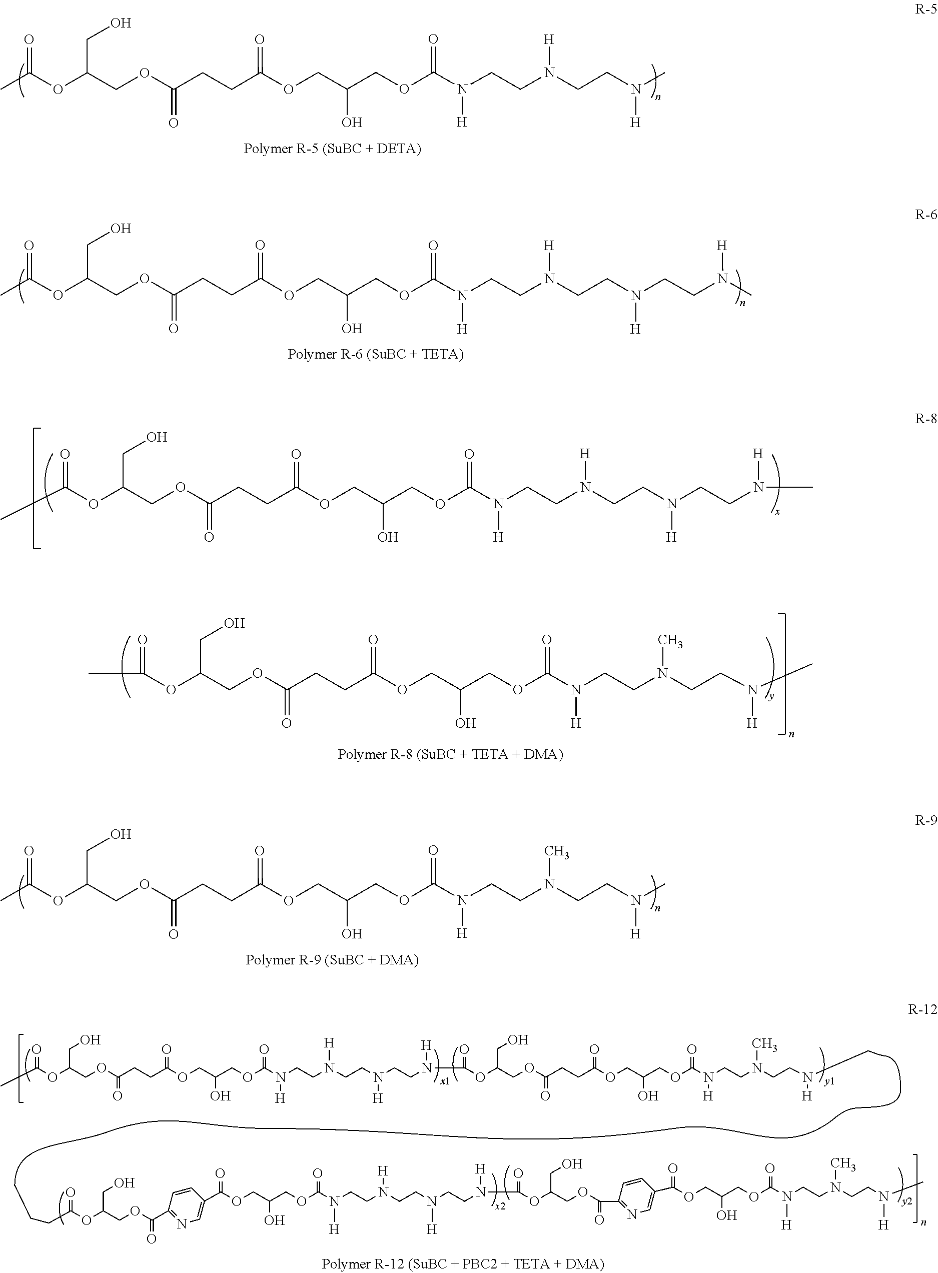

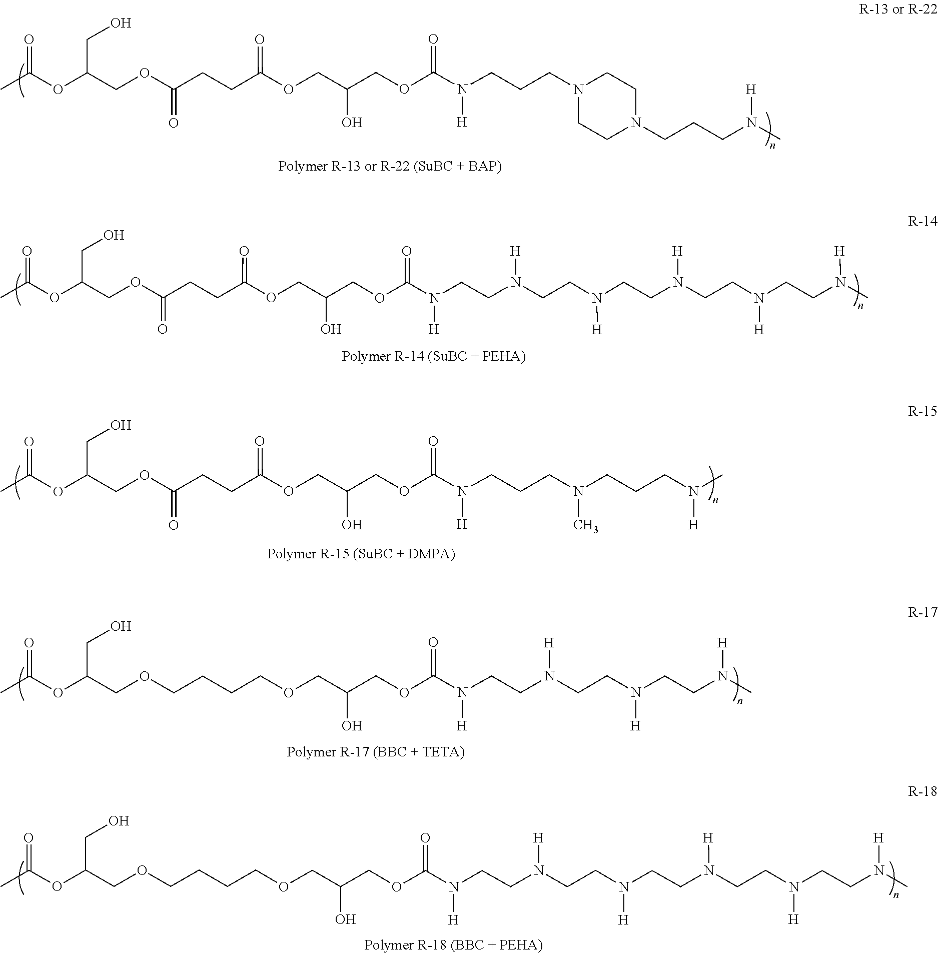

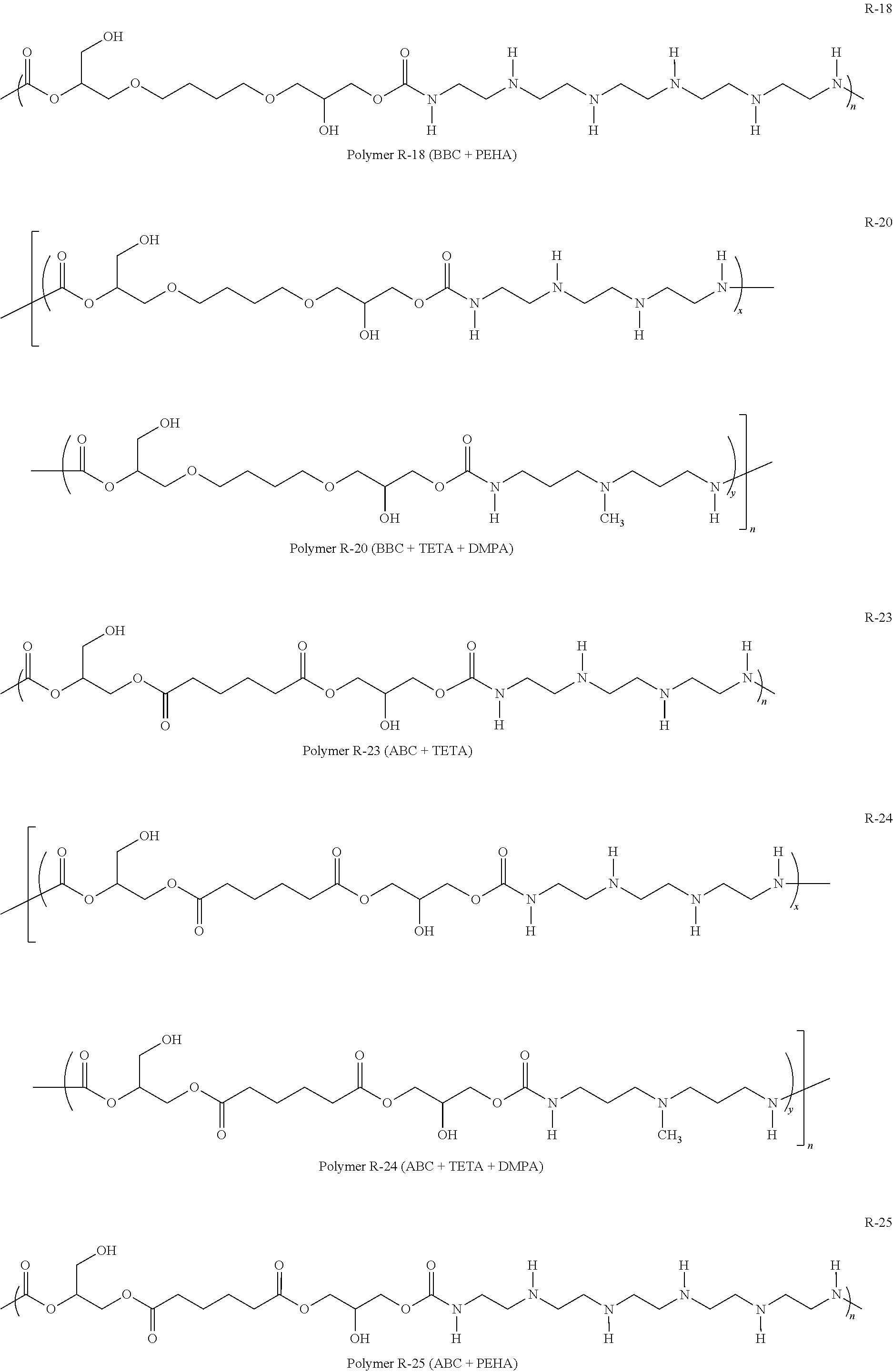

In one embodiment, the polymer or derivative thereof further comprises at least one of a hydroxyl group and an active amine group originally present in the polymer that has been functionalized.

In one embodiment, the polymer or derivative thereof is a grafted polymer obtained by grafting the polymer on a substrate or another polymer.

In one embodiment, the polymer or derivative thereof has one or more of the following properties: water-soluble; hydrolysable; biodegradable; and biocompatible.

In one aspect, there is provided a use of the polymer or derivative thereof disclosed herein as an anti-redepositioning agent, an anti-bacterial agent, an adhesive, an adhesion promoter, a fiber modifier, a pigment dispersant, a chelating agent, a flocculating agent, a wet strength improving additive, a pour point depressant, or a carbon dioxide capture agent.

In one aspect, there is provided a method of preparing the polymer or derivative thereof disclosed herein, the method comprising: polymerizing one or more diamines represented by general formula (1) with one or more biscarbonates represented by general formula (2) to obtain the polymer:

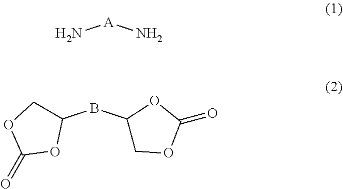

wherein
A comprises a linear aliphatic, branched aliphatic, cyclic and/or aromatic hydrocarbons comprising at least one active amine group; and
B comprises a linear aliphatic, branched aliphatic, cyclic and/or aromatic hydrocarbons that optionally comprises at least one of an ether, amine, ester and combinations thereof.

In one embodiment, the method comprises a) mixing one or more diamines represented by general formula (1) with one or more biscarbonates represented by general formula (2) to obtain a reaction mixture; and b) precipitating the polymer.

In one embodiment, the method further comprises a step of functionalising at least one of a hydroxyl group and an active amine group present in the polymer.

In one embodiment, the method further comprises a step of grafting to at least one of a hydroxyl group and an active amine group present in the polymer to another polymer or substrate.

### Definitions

The term “polymer” as used herein refers to a chemical compound comprising repeating units and is created through a process of polymerization.

The units composing the polymer are typically derived from monomers and/or macromonomers. A polymer typically comprises repetition of a number of constitutional units.

The terms “monomer” or “macromonomer” as used herein refer to a chemical entity that may be covalently linked to one or more of such entities to form a polymer.

The terms “bio-based” or “bio-derived” as used herein broadly refer to the quality of being derived or being originated from living organisms or once-living organisms. Such living organisms may be animal or plants. Therefore, “bio-based source” includes, but is not limited to, a biofeedstock, a plant-based source or combinations thereof.

The term “biocompatible” as used herein broadly refers to a property of being compatible with biological systems or parts of the biological systems without substantially or significantly eliciting an adverse physiological response such as a toxic reaction, an immune reaction, an injury or the like. Such biological systems or parts include blood, cells, tissues, organs or the like.

The term “bond” refers to a linkage between atoms in a compound or molecule. The bond may be a single bond, a double bond, or a triple bond.

The term “alkyl” as a group or part of a group refers to a straight or branched aliphatic hydrocarbon group having 1 to 20 carbon atoms, 1 to 10 carbon atoms, 1 to 6 carbon atoms, or 1, 2, 3, 4, 5, 6, 7, 8, 9, 10, 11, 12, 13, 14, 15, 16, 17, 18, 19 or 20 carbon atoms. Examples of suitable straight and branched alkyl substituents include methyl, ethyl, n-propyl, 2-propyl, isopropyl, n-butyl, isobutyl, sec-butyl, t-butyl, hexyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl and the like. The group may be a terminal group or a bridging group.

The term “alkenyl” as a group or part of a group denotes an aliphatic hydrocarbon group containing at least one carbon-carbon double bond and which may be straight or branched having 2 to 20 carbon atoms, 2 to 10 carbon atoms, 2 to 6 carbon atoms, or 2, 3, 4, 5, 6, 7, 8, 9, 10, 11, 12, 13, 14, 15, 16, 17, 18, 19 or 20 carbon atoms in the chain. The group may contain a plurality of double bonds and the orientation about each double bond is independently E or Z. Exemplary alkenyl groups include, but are not limited to, ethenyl, vinyl, allyl, 1-methylvinyl, 1-propenyl, 2-propenyl, 2-methyl-1-propenyl, 2-methyl-1-propenyl, 1-butenyl, 2-butenyl, 3-butentyl, 1,3-butadienyl, 1-pentenyl, 2-pententyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 2-heptentyl, 3-heptenyl, 1-octenyl, 2-octenyl, 3-octenyl, 1-nonenyl, 2-nonenyl, 3-nonenyl, 1-decenyl, 2-decenyl, 3-decenyl and the like. The group may be a terminal group or a bridging group.

The term “alkynyl” as a group or part of a group denotes an aliphatic hydrocarbon group containing at least one carbon-carbon triple bond and which may be straight or branched having 2 to 20 carbon atoms, 2 to 10 carbon atoms, 2 to 6 carbon atoms, or 2, 3, 4, 5, 6, 7, 8, 9, 10, 11, 12, 13, 14, 15, 16, 17, 18, 19 or 20 carbon atoms in the chain. The group may contain a plurality of triple bonds. Exemplary alkynyl groups include, but are not limited to, acetylenyl, propynyl, 1-butynyl, 2-butynyl, 3-butynyl, 1-pentynyl, 2-pentynyl, 3-methyl-1-butynyl, 4-pentynyl, 1-hexynyl, 2-hexynyl, 5-hexynyl, 1-heptynyl, 2-heptynyl, 6-heptynyl, 1-octynyl, 2-octynyl, 7-octynyl, 1-nonynyl, 2-nonynyl, 8-nonynyl, 1-decynyl, 2-decynyl, 9-decynyl and the like. The group may be a terminal group or a bridging group.

The term “cyclic” as used herein broadly refers to a structure where one or more series of atoms are connected to form at least one ring. The term includes, but is not limited to, both saturated and unsaturated 5-membered and saturated and unsaturated 6-membered rings. Examples of groups having a cyclic structure include, but are not limited to, cyclopentane, cyclopentene, cyclohexane, cyclohexene, benzene and the like. The term “cyclic” as used herein includes “heterocyclic”.

The term “heterocyclic” as used herein broadly refers to a structure where two or more different kinds of atoms are connected to form at least one ring. For example, a heterocyclic ring may be formed by carbon atoms and at least another atom (i.e. heteroatom) selected from oxygen (O), nitrogen (N) or (NR) and sulfur (S), where R is independently a hydrogen or an organic group. The term also includes, but is not limited to, saturated and unsaturated 5-membered, and saturated and unsaturated 6-membered rings. Examples of groups having a heterocyclic structure include, but are not limited to furan, thiophene, 1H-pyrrole, 2H-pyrrole, 1-pyrroline, 2-pyrroline, 3-pyrroline, 1-pyrazoline, 2-pyrazoline, 3-pyrazoline, 2-imidazoline, 3-imidazoline, 4-imidazoline, pyrazole, imidazole, oxazole, isoxazole, thiazole, isothiazole, 1,2,3-triazole, 1,2,4-triazole, 1,2,3-oxadiazole, disubstituted 1,2,4-oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, tetrahydrofuran, tetrahydrothiophene, pyrrolidine, 1,3-dioxolane, 1,2-oxathiolane, 1,3-oxathiolane, pyrazolidine, imidazolidine, pyridine, pyridazine, pyrimidine, pyrazine, 1,2-oxazine, 1,3-oxazine, 1,4-oxazine, thiazine, 1,2,3-triazine, 1,2,4-triazine, 1,3,5-triazine, 2H-pyran, 4H-pyran, 2-pyrone, 4-pyrone, 1,4-dioxin, 2H-thiopyran, 4H-thiopyran, tetrahydropyran, thiane, piperidine, 1,4-dioxane, 1,2-dithiane, 1,3-dithiane, 1,4-dithiane, 1,3,5-trithiane, piperazine, morpholine, thiomorpholine and the like.

The term “aromatic” as used herein when referring to hydrocarbons, refers broadly to hydrocarbons having a ring-shaped or cyclic structure with delocalised electrons between carbon atoms. The term encompasses, but is not limited to, monovalent (“aryl”), divalent (“arylene”) monocyclic aromatic groups having 5 to 6 atoms. Examples of such groups include, but are not limited to, benzene, furan, thiophene, pyrrole, pyrazole, imidazole, oxazole, thiazole, triazole, oxadiazole, thiadiazole, tetrazole, benzofuran, benzothiophene, benzopyrrole, benzodifuran, benzodithiophene, benzodipyrrole, pyridine, pyridazine, pyrimidine, pyrazine, 1,2,3-triazine, 1,2,4-triazine, 1,3,5-triazine and the like.

The term “heteroaromatic” as used herein when referring to hydrocarbons, refers broadly to aromatic hydrocarbons that have one or more carbon atoms replaced by a heteroatom. The term encompasses, but is not limited to, monovalent (“aryl”), divalent (“arylene”) monocyclic, polycyclic conjugated or fused aromatic groups having 5 to 14 atoms, where 1 to 6 atoms in each aromatic ring are heteroatoms selected from oxygen (O), nitrogen (N) or (NH) and sulfur (S). Examples of such groups include, but are not limited to, furan, thiophene, pyrrole, pyrazole, imidazole, oxazole, thiazole, triazole, oxadiazole, thiadiazole, tetrazole, benzofuran, benzothiophene, benzopyrrole, benzodifuran, benzodithiophene, benzodipyrrole, pyridine, pyridazine, pyrimidine, pyrazine, 1,2,3-triazine, 1,2,4-triazine, 1,3,5-triazine and the like.

The term “optionally substituted,” when used to describe a chemical structure or moiety, refers to the chemical structure or moiety wherein one or more of its hydrogen atoms is optionally substituted with a chemical moiety or functional group such as alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH-alkyl- or -alkylNHC(O)alkyl), tertiary amine (such as alkylamino, arylamino, arylalkylamino), aryl, aryloxy, azo, carbamoyl (—NHC(O)O-alkyl- or —OC(O)NH-alkyl), carbamyl (e.g., CONH₂, as well as CONH-alkyl, CONH-aryl, and CONH-arylalkyl), carboxyl, carboxylic acid, carboxylic acid salt (e.g., —COO—Na⁺), cyano, ester, ether (e.g., methoxy, ethoxy), halo, haloalkyl (e.g., —CCl₃, —CF₃, —C(CF₃)₃), heteroalkyl, isocyanate, isothiocyanate, nitrile, nitro, phosphodiester, sulfide, sulfonamido (e.g., SO₂NH₂), sulfone, sulfonyl (including alkylsulfonyl, arylsulfonyl and arylalkylsulfonyl), sulfoxide, thiol (e.g., sulfhydryl, thioether) or urea (—NHCONH-alkyl-).

The term “alkoxy” as used herein refers to straight chain or branched alkyloxy groups. Examples include methoxy, ethoxy, n-propoxy, isopropoxy, tert-butoxy, and the like.

The term “alkoxyalkyl” as used herein is intended to broadly refer to a group containing —R—O—R′, where R and R′ are alkyl as defined herein. The group may be a terminal group or a bridging group.

The term “alkylcarbonyl” as used herein is intended to broadly refer to a group containing —R—C(═O)—, where R is alkyl as defined herein. The group may be a terminal group or a bridging group.

The term “alkylcarbonylalkyl” as used herein is intended to broadly refer to a group containing —R—C(═O)—R′, where R and R′ are alkyl as defined herein.

The group may be a terminal group or a bridging group.

The term “carboxylalkyl” as used herein is intended to broadly refer to a group containing —C(═O)—O—R, where R is alkyl as defined herein. The group may be a terminal group or a bridging group.

The term “oxycarbonylalkyl” as used herein is intended to broadly refer to a group containing —O—C(═O)—R, where R is alkyl as defined herein. The group may be a terminal group or a bridging group.

The term “alkylcarboxylalkyl” as used herein is intended to broadly refer to a group containing —R—C(═O)—O—R′, where R and R′ are alkyl as defined herein.

The group may be a terminal group or a bridging group.

The term “alkoxycarbonylalkyl” as used herein is intended to broadly refer to a group containing —R—O—C(═O)—R′, where R and R′ are alkyl as defined herein. The group may be a terminal group or a bridging group.

The term “oxy” as used herein is intended to broadly refer to a group containing —O—.

The term “carbonyl” as used herein is intended to broadly refer to a group containing —C(═O)—.

The term “oxycarbonyl” as used herein is intended to broadly refer to a group containing —O—C(═O)—.

The term “carboxyl” as used herein is intended to broadly refer to a group containing —C(═O)—O—R, where R is hydrogen or an organic group.

The term “halogen” represents chlorine, fluorine, bromine or iodine. The term “halo” represents chloro, fluoro, bromo or iodo.

The term “amine group” or the like is intended to broadly refer to a group containing —NR₂, where R is independently a hydrogen or an organic group. The group may be a terminal group or a bridging group.

The term “amide group” or the like is intended to broadly refer to a group containing —C(═O)NR₂, where R is independently a hydrogen or an organic group. The group may be a terminal group or a bridging group.

The term “micro” as used herein is to be interpreted broadly to include dimensions from about 1 micron to about 1000 microns.

The term “nano” as used herein is to be interpreted broadly to include dimensions less than about 1000 nm, less than about 500 nm, less than about 100 nm or less than about 50 nm.

The term “particle” as used herein broadly refers to a discrete entity or a discrete body. The particle described herein can include an organic, an inorganic or a biological particle. The particle used described herein may also be a macro-particle that is formed by an aggregate of a plurality of sub-particles or a fragment of a small object. The particle of the present disclosure may be spherical, substantially spherical, or non-spherical, such as irregularly shaped particles or ellipsoidally shaped particles. The term “size” when used to refer to the particle broadly refers to the largest dimension of the particle. For example, when the particle is substantially spherical, the term “size” can refer to the diameter of the particle; or when the particle is substantially non-spherical, the term “size” can refer to the largest length of the particle.

The terms “coupled” or “connected” as used in this description are intended to cover both directly connected or connected through one or more intermediate means, unless otherwise stated.

The term “associated with”, used herein when referring to two elements refers to a broad relationship between the two elements. The relationship includes, but is not limited to a physical, a chemical or a biological relationship.

For example, when element A is associated with element B, elements A and B may be directly or indirectly attached to each other or element A may contain element B or vice versa.

The term “adjacent” used herein when referring to two elements refers to one element being in close proximity to another element and may be but is not limited to the elements contacting each other or may further include the elements being separated by one or more further elements disposed therebetween.

The term “and/or”, e.g., “X and/or Y” is understood to mean either “X and Y” or “X or Y” and should be taken to provide explicit support for both meanings or for either meaning.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For example, when “comprising” is used, reference to a “one” feature is also intended to be a reference to “at least one” of that feature. Terms such as “consisting”, “consist”, and the like, may in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. It is to be appreciated that the individual numerical values within the range also include integers, fractions and decimals. Furthermore, whenever a range has been described, it is also intended that the range covers and teaches values of up to 2 additional decimal places or significant figures (where appropriate) from the shown numerical end points. For example, a description of a range of 1% to 5% is intended to have specifically disclosed the ranges 1.00% to 5.00% and also 1.0% to 5.0% and all their intermediate values (such as 1.01%, 1.02% . . . 4.98%, 4.99%, 5.00% and 1.1%, 1.2% . . . 4.8%, 4.9%, 5.0% etc.) spanning the ranges. The intention of the above specific disclosure is applicable to any depth/breadth of a range.

Additionally, when describing some embodiments, the disclosure may have disclosed a method and/or process as a particular sequence of steps. However, unless otherwise required, it will be appreciated that the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Furthermore, it will be appreciated that while the present disclosure provides embodiments having one or more of the features/characteristics discussed herein, one or more of these features/characteristics may also be disclaimed in other alternative embodiments and the present disclosure provides support for such disclaimers and these associated alternative embodiments.

### DESCRIPTION OF EMBODIMENTS

Exemplary, non-limiting embodiments of a polymer comprising a plurality of active amine groups in the backbone of the polymer, a derivative thereof, use of said polymer, and a method of preparing said polymer or a derivative thereof are disclosed hereinafter.

There is provided a polymer comprising a plurality of active amine groups.

In various embodiments, the active amine groups comprise active amine groups present in the backbone of the polymer. Advantageously, the active amine groups are designed to be tunable and/or customizable, depending on the application the polymer is to be used for. In various embodiments, the functionalities and/or properties of the polymer can be changed or tuned, depending on the type of amine groups present in the polymer. The active amine groups may be selected from the group consisting of secondary (2°) amine, tertiary (3°) amine, quaternary ammonium cations (i.e. NR₄⁺) and combinations thereof. For example, a polymer having secondary (2°) amine groups are preferred for applications as additives such as in shampoo, detergents and/or cosmetics due to its anti-redepositioning property. A polymer having secondary (2°) amine groups are also preferred for applications as anti-bacterial materials due to its anti-bacterial property. A polymer having secondary (2°) amine groups are also preferred for applications as adhesive or adhesion promoter due to its hydrogen bonding ability. A polymer having secondary (2°) amine groups are also preferred for water treatment applications as chelating or flocculating agents due to its metal chelation or metal binding ability.

In various embodiments, the plurality of active amine groups comprise a plurality of different amine functionalities. The amine group/functionality may be selected from the group consisting of secondary (2°) amine, tertiary (3°) amine, quaternary ammonium cations (i.e. NR₄⁺) and combinations thereof. In various embodiments, the active amine groups comprise aliphatic amine groups, aromatic amine groups, cyclic amine groups, or combinations thereof. The aliphatic amine may comprise aliphatic secondary amines, aliphatic tertiary amines, aliphatic quaternary ammonium cations, or combinations thereof. The cyclic amine may comprise cyclic secondary amines such as piperazine, imidazolidine, 1,4-diazepane, piperidine, pyrrolidine; cyclic tertiary amines such as N-methylpiperidine and N-phenylpiperidine; cyclic quaternary ammonium cations, or combinations thereof. The aromatic amine may comprise aromatic secondary amines such as diphenylamine; aromatic tertiary amines such as pyridine, pyrimidine, quinoline, acridine; aromatic quaternary ammonium cations, or combinations thereof.

In various embodiments, the nitrogen (N) content of the polymer ranges from about 1% to about 30%, from about 2% to about 29%, from about 3% to about 28%, from about 4% to about 27%, from about 5% to about 26%, from about 6% to about 25%, from about 7% to about 24%, from about 8% to about 23%, from about 9% to about 22%, from about 10% to about 21%, from about 11% to about 20%, from about 12% to about 19%, from about 13% to about 18%, from about 14% to about 17%, or from about 15% to about 16% by weight of the polymer.

Advantageously, due to the presence of a plurality of active amine groups in the backbone, embodiments of the polymer disclosed herein have a higher water solubility and/or water dispersibility than conventional amine functional polymers. For example, the polymer may be more water soluble/dispersible as compared to conventional amine functional polymers such as polyaniline (2° amine), poly(4-aminostyrene) (1° amine), poly(4-vinylpyridine) (aromatic amine), poly(2-(dimethylamino)ethyl methacrylate) or poly(DMAEMA) (3° amine), poly(allylamine) (1° amine), poly(vinylamine) (1° amine), polylysine (1° amine), linear polyethylenimine (PEI) (2° amine), branched polyethylenimine (PEI) (that contains 1°, 2° and 3° amine groups) and branched PEI-g-PEG (that contains 1° and 2° amine groups).

In various embodiments, the polymer is a water-soluble/dispersible polymer, for example, under ambient conditions such as a temperature of about 20° C. to 40° C. The polymer may be soluble in water in both acidic and basic conditions. For example, the polymer can dissolve at a pH below about 3 or in the range of from about 3 to about 10. In some embodiments, the polymer can dissolve at a pH of about 0, pH of about 1, pH of about 2, pH of about 3, pH of about 4, pH of about 5, pH of about 6, pH of about 7, pH of about 8, pH of about 9 or pH of about 10.

In various embodiments, the polymer is organic solvent-soluble polymer. The polymer may be soluble in an organic solvent, e.g. dimethylformamide (DMF), tetrahydrofuran (THF), acetone, dichloromethane (DCM), acetonitrile (ACN), acetone, dimethyl sulfoxide (DMSO) and an alkyl alcohol such as methanol (MeOH), ethanol or propanol.

In various embodiments, the polymer is a cationic polymer. In various embodiments, the polymer is positively charged or comprises an overall net positive charge(s). In various embodiments, the active amine groups (e.g., 2° amine and/or 3° amine groups) present in the polymer becomes partially or completely protonated (e.g., gains protons) via an adjustment in pH value. For example, by lowering the pH value, the 2° amine groups (—NH—) present in the polymer may gain protons (H⁺) to form positively charged cations (—NH₂⁺—). Advantageously, the positive charge(s) on the polymer allows for embodiments of the polymer to possess anti-redepositioning property, making the polymer ideal/attractive/suitable for use as an additive in shampoo, detergent and/or cosmetics. Without being bound by theory, it is believed that the positive charge(s) on the polymer allow for embodiments of the polymer to be adsorb onto negatively charged particles (e.g., clay or soil particles/deposits), which results in a repulsive force and thereby preventing redeposition of such negatively charged particles during washing.

In various embodiments, the polymer further comprises at least one of an ester group, an ether group, a hydroxyl group, a carbamate/urethane group or combinations thereof. In some embodiments, the polymer comprises at least one ester group, at least one ether group, at least one hydroxyl group, at least one carbamate/urethane group, and a plurality of amine groups. In some embodiments, a plurality of ester groups, a plurality of ether groups, a plurality of hydroxyl group, a plurality of carbamate/urethane groups, and a plurality of amine groups are present in the polymer.

In various embodiments, the polymer comprises monomeric units that are joined/linked together via carbamate/urethane linkages. In various embodiments therefore, the polymer is a polyurethane (PU) polymer.

In various embodiments, the polymer comprises a plurality of hydroxyl groups and a plurality of carbamate/urethane linkages. In various embodiments therefore, the polymer is a polyhydroxyurethane (PHU) polymer.

Advantageously, embodiments of the polymer is substantially devoid of a toxic isocyanate or phosgene. In various embodiments, the polymer is a non-isocyanate polymer, a non-isocyanate polyurethane or a non-isocyanate polyhydroxyurethane.

In various embodiments, the polymer is hydrolysable. Advantageously, the hydrolysability (e.g., due to presence of a plurality of ester groups and/or urethane groups) of the polymer allows for embodiments of the polymer to be degradable, hydrolytic degradable, biodegradable and/or broken down naturally, making the polymer ideal/attractive/suitable for use in applications which require materials used therein to be biocompatible, non-toxic and/or non-skin irritant, for e.g., as antibacterial or anti-fungal agents. In various embodiments, the polymer is compatible with biological systems or parts of the biological systems without substantially or significantly eliciting an adverse physiological response such as a toxic reaction/response, an immune reaction/response, an injury or the like when used on the human or animal body. In various embodiments, the polymer is substantially devoid of materials that elicit an adverse physiological response. It will be appreciated that most conventional amine functional polymers such as polyaniline (2° amine), poly(4-aminostyrene) (1° amine), poly(4-vinylpyridine) (aromatic amine), poly(2-(dimethylamino)ethyl methacrylate) or poly(DMAEMA) (3° amine), poly(allylamine) (1° amine), poly(vinylamine) (1° amine), linear polyethylenimine (PEI) (2° amine), branched polyethylenimine (PEI) (that contains 1°, 2° and 3° amine groups) and branched PEI-g-PEG (that contains 1° and 2° amine groups) are non-degradable.

In various embodiments, the polymer has a rate of hydrolysis, degradation and/or hydrolytic degradation that is higher/faster at a higher pH, for e.g., at a pH above 8.5, at a pH of from about pH 9 to about pH 13, from about pH 10 to about pH 12, or about pH 11. In various embodiments, the rate of hydrolysis and/or degradation is higher at a higher temperature, for e.g., at a temperature that is higher than room temperature, at a temperature above about 25° C., above about 50° C., above about 100° C. or above about 125° C.

In various embodiments, the polymer has a degradability, hydrolytic degradability, biodegradability or biodegradable rate of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or about 100% (e.g., complete biodegradation) over a time period of about 6 hours, about 12 hours, about 24 hours, about 2 days, about 3 days, about 4 days, about 5 days, about 6 days, about 7 days, about 8 days, about 9 days, about 10 days, about 15 days, about 20 days, about 25 days, about 30 days, about 35 days, about 40 days, about 45 days, about 50 days, about 55 days, about 60 days, about 70 days or about 80 days. The polymer may be substantially susceptible to degradation by biological activity.

In various embodiments, the polymer is capable of undergoing hydrogen bonding. Advantageously, this property of the polymer allows for embodiments of the polymer to be used as adhesive or adhesion promoter. For example, active amine groups (e.g., 2° amine), hydroxyl groups and/or urethane groups present in the polymer may undergo hydrogen bonding. The polymer may undergo hydrogen bonding in aqueous medium (e.g., water), ammonia, alcohols or carboxylic acids.

In various embodiments, the polymer comprises metal-chelating/binding property. In various embodiments, the polymer is capable of binding/chelating metal. Advantageously, this property of the polymer allows for embodiments of the polymer to be used in the formation of metal chelate complex, metal coordination or complex compound. For example, active amine group(s) (e.g., 2° amine, 3° amine, and/or quaternary ammonium cations) present in the polymer may react with or bind to a metal (e.g., metal atom or ion) to form a metal coordination or complex compound. Hydroxyl group(s) present in the polymer may also react with or bind to a metal (e.g., metal atom or ion) to form a metal coordination or complex compound. In various embodiments, the polymer comprises N-chelating groups and/or OH-chelating groups. In various embodiments, the polymer is capable of binding/chelating metal or forming metal chelate complex with metal, e.g. transition metals such as copper, nickel, cobalt, iron, manganese, chromium, vanadium, titanium, zinc, ruthenium, rhodium, palladium or the like. The metal may be a metal atom or metal ion.

In various embodiments, the polymer comprises antibacterial property. Advantageously, this property of the polymer (e.g., due to the presence of 2° amine and/or 3° amine groups) allows for embodiments of the polymer to be used as antibacterial or anti-fungal agents. For example, the polymer may be functionalized with acrylates (e.g., fluorinated acrylates) to make hydrophobic anti-bacterial materials.

In various embodiments, the polymer is capable of undergoing quaternization. For example, active amine groups (e.g., 3° amine and aromatic amine) present in the polymer may undergoes quaternization.

In various embodiments, the polymer is capable of undergoing nucleophilic addition reactions such as Aza-Michael reaction (e.g. room temperature atom-efficient Aza-Michael) and/or amine-epoxide nucleophilic addition reaction with another reactant. The reactant may be α,β-unsaturated carbonyl compounds and epoxy compounds. Advantageously, in various embodiments, the polymer may be functionalized/grafted through nucleophilic addition reactions in the absence of catalyst and/or formation of by-products. The nucleophilic addition reactions such as Aza-Michael reaction and/or amine-epoxide reaction may occur at one or more of the chemical moieties selected from an ester group, an ether group, a hydroxyl group, a carbamate/urethane group or an active amine group (e.g., 2° amine groups) present in the polymer.

In various embodiments, the polymer is capable of being cross-linked. The polymer may be a crosslinkable polymer. In various embodiments, the polymer is cross-linked by using cross-linking agents which include, but is not limited to, acrylates (e.g., bisacrylates) and epoxy compounds (e.g., bisepoxy compounds). Advantageously, this property of the polymer allows for embodiments of the polymer to be made/synthesized into hydrogels. For example, the polymer (hydroxyl and/or amine groups in the polymer) may be cross-linked/functionalized with poly(ethylene glycol) diglycidyl ether (PEGE) to form hydrogels. Advantageously, this property of the polymer also allow for embodiments of the polymer to form a crosslinked coating. For example, the polymer (hydroxyl and/or amine groups in the polymer) may be cross-linked/functionalized with 1,4-butanediol diacrylate (BDDA) to form a crosslinked coating or insoluble film.

In various embodiments, the polymer is capable of forming reversible cross-links. In various embodiments therefore, the polymer is a reversibly crosslinkable polymer.

In various embodiments, the polymer is capable of capturing carbon dioxide (CO₂) or being used as a carbon dioxide (CO₂) capture material. In one embodiment, the polymer is capable of being used for CO₂ capture with capture effectiveness that is similar/comparable/superior to polyethylenimine (PEI)/aminoethanol. In various embodiments, the polymer is capable of releasing captured CO₂ at a temperature that is lower than that of commercial/conventional system such as monoethanolamine (MEA) solution. In various embodiments, the polymer is capable of releasing captured CO₂ at a temperature of about 120° C., below about 120° C., below about 110° C., below about 100° C., below about 90° C., below about 80° C. or below about 70° C.

In various embodiments, the polymer is capable of interacting fibers and surfaces of like cotton, polyesters (may be hair, pigments, clay as well) and may be used as a surface modification additive. Because of this interaction, embodiments of the polymer may be used as an anti-redepositioning agent for fabrics.

In various embodiments, the polymer is capable of being functionalised to produce at least one of a crosslinked coating, a hydrogel, an antibacterial polymer (e.g permanently cationic), an antifouling agent, a hydrophobic polymer, a fluorinated functional polymer, an oil-soluble polymer, a pour point polymer/depressant, a cationic polymer, zwitterionic polymer, anionic polymer, oleophobic polymer, an enhanced bio-based polymer with increased bio-content, or a precursor to a graft polymer, optionally in the absence of a catalyst.

In various embodiments, the polymer is capable of being functionalised to produce a long chain fatty acid modified amine polymer that is capable of reducing pour point and/or viscosity and/or storage modulus of wax or oil such as synthetic oil and crude oil. In various embodiments, the functionalised polymer displays a pour point depressant property that is better than commercial/conventional system such as poly(octadecyl acrylate).

In various embodiments, the polymer is a reaction product of a reaction between one or more bis-carbonates and one or more amine compounds having at least two terminal amino groups.

In various embodiments, the polymer is a bio-based polymer. In various embodiments, at least one of the monomers (i.e. bis-carbonates and the amine compounds having at least two terminal amino groups) is derived from a bio-based source. In one embodiment, at least the amine compound is bio-based. In one embodiment, at least the bis-carbonate is bio-based. In one embodiment, both monomers (i.e. bis-carbonates and the amine compounds having at least two terminal amino groups) are bio-based or derived from a bio-based source. The polymers disclosed herein are advantageous over conventional amine polymers at least in that the monomers are bio-based/bio-derived. In various embodiments therefore, the reaction products disclosed herein are innocuous biocompatible polymers, making them attractive as alternative sustainable materials for future applications.

In various embodiments, the polymer comprises a high bio-content. The content of the polymer derived from a bio-based source may range from about 20% to about 90% by weight of the polymer. The content of the content of the polymer derived from a bio-based source may range from about 20% to about 90%, from about 25% to about 85%, from about 30% to about 80%, from about 35% to about 75%, from about 40% to about 70%, from about 45% to about 65%, from about 50% to about 60%, or about 55% by weight of the polymer.

In various embodiments, the polymer is a reaction product of a reaction between one or more amine compounds having at least two terminal amino groups represented by general formula (1), one or more bis-carbonates represented by general formula (2), and optionally one or more amine compounds having at least two terminal amino groups represented by general formula (12):

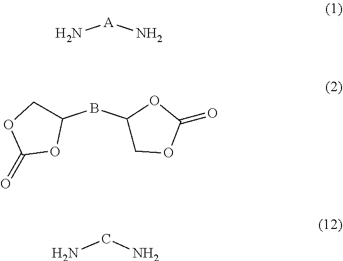

wherein
A comprises a linear aliphatic, branched aliphatic, cyclic and/or aromatic hydrocarbons comprising at least one amine group (e.g., active amine group);
B comprises a linear aliphatic, branched aliphatic, cyclic and/or aromatic hydrocarbons that optionally comprises at least one of an ether, amine, ester and combinations thereof; and C comprises a linear aliphatic, branched aliphatic, cyclic and/or aromatic hydrocarbons.

In various embodiments, the polymer comprises one or more structural units represented by general formula (3), one or more structural units represented by general formula (4), and optionally one or more structural units represented by general formula (13):

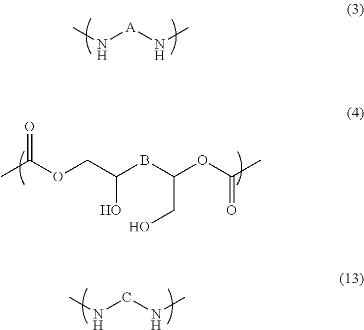

wherein
A comprises a linear aliphatic, branched aliphatic, cyclic and/or aromatic hydrocarbons comprising at least one amine group (e.g., active amine group);
B comprises a linear aliphatic, branched aliphatic, cyclic and/or aromatic hydrocarbons that optionally comprises at least one of an ether, amine, ester or combinations thereof; and
C comprises a linear aliphatic, branched aliphatic, cyclic and/or aromatic hydrocarbons.

In various embodiments, the structural units represented by general formula (3) are linked to structural units represented by general formula (4) via carbamate/urethane linkages. For example, the polymer may comprise one or more of the following structural units:

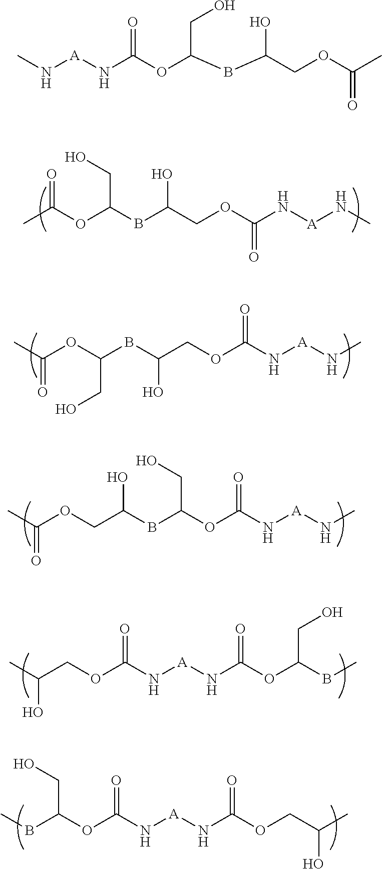

In various embodiments, the polymer comprises structural units represented by general formula (13). For example, the structural units represented by general formula (13) may also be linked to structural units represented by general formula (4) via carbamate/urethane linkages.

In various embodiments, the repeating/structural units represented by general formula (3) present in the polymer may have the same or different types of A. In various embodiments, the repeating/structural units represented by general formula (4) present in the polymer may have the same or different types of B. In various embodiments, the repeating/structural units represented by general formula (13) present in the polymer may have the same or different types of C.

In various embodiments, A is selected from the following general formula (5), (6), (7) or (8):

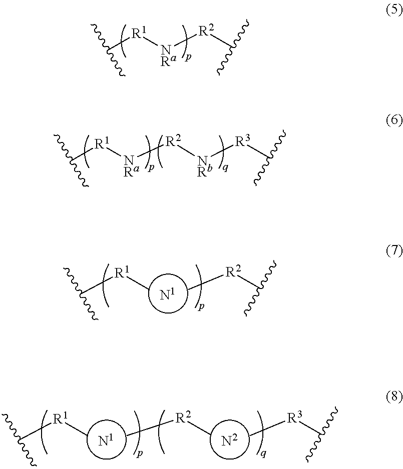

wherein
R¹, R² and R³ are each independently selected from a single bond, optionally substituted alkyl, optionally substituted alkenyl, optionally substituted alkynyl, optionally substituted cycloalkyl or optionally substituted cycloalkenyl;
R^{a} and R^{b} are each independently selected from the group consisting of H, optionally substituted alkyl, optionally substituted alkenyl and optionally substituted alkynyl;
ring N¹ and N² are each independently an optionally substituted 5-membered or 6-membered nitrogen-containing cyclic ring;
p≥1; and q≥0. It will be appreciated that R¹ and/or R² may be bonded to any available positions on ring N¹ and R² and/or R³ may be bonded to any available positions on ring N².

In various embodiments, R¹, R² and R³ are each independently selected from a single bond, optionally substituted C₁-C₂₀ alkyl, C₁-C₂₀ optionally substituted alkenyl, C₁-C₂₀ optionally substituted alkynyl, C₁-C₂₀ optionally substituted cycloalkyl and C₁-C₂₀ optionally substituted cycloalkenyl. In various embodiments, R^{a} and R^{b} are each independently selected from the group consisting of H, optionally substituted C₁-C₂₀ alkyl, optionally substituted C₁-C₂₀ alkenyl and optionally substituted C₁-C₂₀ alkynyl.

In various embodiments, R¹, R² and R³ are each independently C₁-C₂₀ alkyl substituents. In various embodiments, R^{a} and R^{b} are each independently selected from the group consisting of H and C₁-C₂₀ alkyl substituents. The C₁-C₂₀ alkyl substituents may be straight or branched substituents selected from methyl, ethyl, n-propyl, 2-propyl, isopropyl, n-butyl, isobutyl, sec-butyl, t-butyl, hexyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl or the like. For example, R¹, R² and R³ may be each independently selected from the group consisting of —CH—, —CH₂CH₂—, —CH₂CH₂CH₂— and —CH₂CH₂CH₂CH₂—. R^{a} and R^{b} may be each independently selected from the group consisting of —H and —CH₃.

In various embodiments, ring N¹ and N² are cyclic and/or aromatic amines. In various embodiments, ring N¹ and N² are each independently selected from the group consisting of 3-pyrroline, 2-pyrroline, 2H-pyrrole, 1H-pyrrole, 2-pyrazoline, 2-imidazoline, pyrazole, imidazole, 1,2,4-triazole, 1,2,3-triazole, oxazole, isoxazole, isothiazole, thiazole, 1,2,5-oxadiazole, 1,2,3-oxadizole, 1,3,4-thiadiazole, 1,2,5-thiadiazole, diphenylamine, pyridine, pyridazine, pyrimidine, pyrazine, 1,2,4-triazine, 1,3,5-triazine, oxazine, thiazine, pyrazolidine, imidazolidine, piperidine, N-methylpiperidine, N-phenylpiperidine, pyrrolidine, piperazine, morpholine, thiomorpholine, 1,4-diazepane, quinoline, acridine and combinations thereof.

In various embodiments, p≥1. For example, p may be 1, 2, 3, 4, 5, 6, 7, 8, 9, 10, 11, 12, 13, 14, 15, 16, 17, 18, 19, 20, 25, 30, 35, 40, 45, or 50. In various embodiments, q≥0. For example, q is 0, 1, 2, 3, 4, 5, 6, 7, 8, 9, 10, 11, 12, 13, 14, 15, 16, 17, 18, 19, 20, 25, 30, 35, 40, 45, or 50.

In some embodiments, R¹ and R² are each —CH₂CH₂—, A is general formula (5) and R^{a} is —H. In such embodiments, the polymer comprises a reaction product derived from diethylenetriamine (DETA). In some embodiments, R¹ and R² are each —CH₂CH₂—, A is general formula (5) and R^{a} is —CH₃. In such embodiments, the polymer comprises a reaction product derived from diamino-N-methyldiethylamine (DMA). In some embodiments, R¹ and R² are each —CH₂CH₂CH₂—, A is general formula (5) and R^{a} is —H. In such embodiments, the polymer comprises a reaction product derived from spermidine. In some embodiments, R¹ and R² are each —CH₂CH₂CH₂—, A is general formula (5) and R^{a} is —CH₃. In such embodiments, the polymer comprises a reaction product derived from diamino-N-methyldipropylamine (DMPA). In some embodiments, R¹, R² and R³ are each —CH₂CH₂—, A is general formula (6) and R^{a} is —H. In such embodiments, the polymer comprises a reaction product derived from triethylenetetramine (TETA) and/or pentaethylenehexamine (PEHA). In some embodiments, R¹ and R³ are each —CH₂CH₂CH₂—, R² is —CH₂CH₂CH₂CH₂—, A is general formula (6) and R^{a} is —H. In such embodiments, the polymer comprises a reaction product derived from spermine. In some embodiments, R¹ and R² are each —CH₂CH₂CH₂—, A is general formula (7) and ring N¹ is piperazine. In such embodiments, the polymer comprises a reaction product derived from bis(3-aminopropyl)piperazine (BAP).

In various embodiments, the one or more bis-carbonates represented by general formula (2) are derived from long chain or aromatic bis olefins. For example, B in general formula (2) comprises a linear aliphatic, branched aliphatic, cyclic and/or aromatic hydrocarbons.

In various embodiments, B comprises a linear aliphatic, branched aliphatic, cyclic and/or aromatic hydrocarbons comprising at least one of an ether, amine, ester and combinations thereof.

In various embodiments, B is selected from the following general formula (9), (10) or (11):

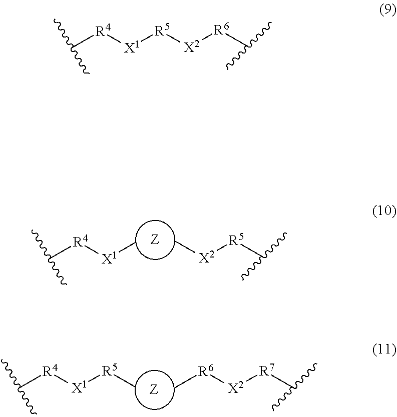

wherein
R⁴, R⁵, R⁶ and R⁷ are each independently selected from a single bond, optionally substituted alkyl, optionally substituted alkenyl, optionally substituted alkynyl, optionally substituted cycloalkyl or optionally substituted cycloalkenyl;
X¹ and X² are each independently selected from the group consisting of a single bond, —O—, —NR^{c}—, —C(═O)—O— and —O—C(═O)—, wherein R^{c} is selected from the group consisting of H, optionally substituted alkyl, optionally substituted alkenyl and optionally substituted alkynyl; and
ring Z is an optionally substituted 5-membered or 6-membered hydrocarbon cyclic ring or an optionally substituted 5-membered or 6-membered heterocyclic ring having up to three heteroatoms independently selected from the group consisting of O, N, S and NH.

It will be appreciated that X¹ and/or X² may be bonded to any available positions on ring Z and R⁵ and/or R⁶ may be bonded to any available positions on ring Z.

In various embodiments, R⁴, R⁵, R⁶ and R⁷ are each independently selected from a single bond, optionally substituted C₁-C₂₀ alkyl, C₁-C₂₀ optionally substituted alkenyl, C₁-C₂₀ optionally substituted alkynyl, C₁-C₂₀ optionally substituted cycloalkyl and C₁-C₂₀ optionally substituted cycloalkenyl. In various embodiments, R^{c} is selected from the group consisting of H, optionally substituted C₁-C₂₀ alkyl, optionally substituted C₁-C₂₀ alkenyl and optionally substituted C₁-C₂₀ alkynyl.

In various embodiments, R⁴, R⁵, R⁶ and R⁷ are each independently C₁-C₂₀ alkyl substituents. In various embodiments, R^{c} is selected from the group consisting of H and C₁-C₂₀ alkyl substituents. The C₁-C₂₀ alkyl substituents may be straight or branched substituents selected from methyl, ethyl, n-propyl, 2-propyl, isopropyl, n-butyl, isobutyl, sec-butyl, t-butyl, hexyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl or the like. For example, R⁴, R⁵, R⁶ and R⁷ may be each independently selected from the group consisting of —CH—, —CH₂CH₂—, —CH₂CH₂CH₂— and —CH₂CH₂CH₂CH₂—.

In various embodiments, ring Z is a 5-membered heterocyclic ring having three heteroatoms, two heteroatoms or one heteroatom independently selected from the group consisting of O, N, S and NH. For example, ring Z may be selected from a furan (e.g. disubstituted furan), a thiophene (e.g. disubstituted thiophene), a pyrrole (e.g. disubstituted 1H-pyrrole, disubstituted 2H-pyrrole), pyrone, a pyrroline (e.g. disubstituted 1-pyrroline, disubstituted 2-pyrroline, disubstituted 3-pyrroline), a pyrazoline (e.g. disubstituted 1-pyrazoline, disubstituted 2-pyrazoline, disubstituted 3-pyrazoline), an imidazoline (e.g. disubstituted 2-imidazoline, disubstituted 3-imidazoline, disubstituted 4-imidazoline), a pyrazole (e.g. disubstituted pyrazole), a imidazole (e.g. disubstituted imidazole), a oxazole (e.g. disubstituted oxazole, disubstituted isoxazole), a thiazole (e.g. disubstituted thiazole, disubstituted isothiazole), a triazole (e.g. disubstituted 1,2,3-triazole, disubstituted 1,2,4-triazole), a oxadiazole (e.g. disubstituted 1,2,3-oxadiazole, disubstituted 1,2,4-oxadiazole, disubstituted 1,2,5-oxadiazole, disubstituted 1,3,4-oxadiazole), a thiadiazole (e.g. disubstituted 1,2,3-thiadiazole, disubstituted 1,2,4-thiadiazole, disubstituted 1,2,5-thiadiazole, disubstituted 1,3,4-thiadiazole), a tetrahydrofuran (e.g. disubstituted tetrahydrofuran), a tetrahydrothiophene (e.g. disubstituted tetrahydrothiophene), a pyrrolidine (e.g. disubstituted pyrrolidine), a dioxolane (e.g. disubstituted 1,3-dioxolane, disubstituted 1,2-oxathiolane, disubstituted 1,3-oxathiolane), a pyrazolidine (e.g. disubstituted pyrazolidine), a imidazolidine (e.g. disubstituted imidazolidine) and the like. It will be appreciated that in various embodiments, ring Z may be termed as a disubstituted ring due to it having two bonds to X¹ and X² or R⁵ and R⁶.

In various embodiments, the 5-membered heterocyclic ring is heteroaromatic. In such embodiments, ring Z is selected from disubstituted furan, disubstituted thiophene, disubstituted pyrrole, disubstituted pyrazole, disubstituted imidazole, oxazole, disubstituted thiazole, disubstituted triazole, disubstituted oxadiazole, disubstituted thiadiazole and the like.

In various embodiments, ring Z is a 6-membered hydrocarbon cyclic ring. For example, ring Z may be selected from disubstituted cyclohexane, disubstituted cyclohexene and disubstituted benzene.

In various embodiments, ring Z is a 6-membered heterocyclic ring having three heteroatoms, two heteroatoms or one heteroatom independently selected from the group consisting of O, N, S and NH. For example, ring Z may be selected from disubstituted pyridine, disubstituted pyridazine, disubstituted pyrimidine, disubstituted pyrazine, disubstituted 1,2-oxazine, disubstituted 1,3-oxazine, disubstituted 1,4-oxazine, disubstituted thiazine, disubstituted 1,2,3-triazine, 1,2,4-triazine, disubstituted 1,3,5-triazine, disubstituted 2H-pyran, disubstituted 4H-pyran, disubstituted 1,4-dioxin, disubstituted 2H-thiopyran, disubstituted 4H-thiopyran, disubstituted tetrahydropyran, disubstituted thiane, disubstituted piperidine, disubstituted 1,4-dioxane, disubstituted 1,2-dithiane, disubstituted 1,3-dithiane, disubstituted 1,4-dithiane, disubstituted 1,3,5-trithiane, disubstituted piperazine, disubstituted morpholine, disubstituted thiomorpholine and the like.

In various embodiments, the 6-membered hydrocarbon ring Z is heteroaromatic. In such embodiments, ring Z is selected from disubstituted pyridine, disubstituted pyridazine, disubstituted pyrimidine, disubstituted pyrazine, disubstituted 1,2,3-triazine, disubstituted 1,2,4-triazine and disubstituted 1,3,5-triazine and the like.

In various embodiments, ring Z is selected from the group consisting of disubstituted furan, disubstituted tetrahydrofuran and disubstituted pyridine. In various embodiments, ring Z is selected from the group consisting of 2,5-disubstituted furan, 3,4-disubstituted furan, 2,3-disubstituted furan, 2,4-disubstituted furan, 2,5-disubstituted pyridine, 2,6-disubstituted pyridine, 2,3-disubstituted pyridine, 2,4-disubstituted pyridine, 3,5-disubstituted pyridine, 3,4-disubstituted pyridine, 3,4-disubstituted tetrahydrofuran, 2,5-disubstituted tetrahydrofuran, 2,3-disubstituted tetrahydrofuran and 2,4-disubstituted tetrahydrofuran. In some embodiments, ring Z is 2,5-disubstituted furan, 2,5-disubstituted pyridine, 2,6-disubstituted pyridine, 2,4-disubstituted pyridine, 3,5-disubstituted pyridine, or 3,4-disubstituted tetrahydrofuran.

In various embodiments, C comprises a linear aliphatic, branched aliphatic, cyclic and/or aromatic hydrocarbons. In various embodiments, C comprises optionally substituted C₁-C₂₀ alkyl, C₁-C₂₀ optionally substituted alkenyl, C₁-C₂₀ optionally substituted alkynyl, C₁-C₂₀ optionally substituted cycloalkyl and C₁-C₂₀ optionally substituted cycloalkenyl. The C₁-C₂₀ alkyl substituents may be straight or branched substituents selected from methyl, ethyl, n-propyl, 2-propyl, isopropyl, n-butyl, isobutyl, sec-butyl, t-butyl, hexyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl or the like. For example, C may be selected from the group consisting of —CH—, —CH₂CH₂—, —CH₂CH₂CH₂— and —CH₂CH₂CH₂CH₂—. C may also be optionally substituted with carboxylic acid salt (e.g., —COO—Na⁺).

Advantageously, embodiments of the polymer disclosed herein are highly customizable. Depending on the application that the polymer is intended, an amine compound having at least two terminal amino groups with the desired amine functionalities (i.e. A) may be selected to combine with a bis-carbonate with the desired chemical functionalities (i.e. B) to eventually obtain the polymer with the desired structural/repeating units represented by general formulae (3) and (4).

In various embodiments, the polymer is derived from two or more different types of bis-carbonates. In various embodiments, the polymer is derived from 2, 3, 4, 5, 6, 7, 8, 9 or 10 different types of bis-carbonates.

In various embodiments, the polymer is derived from two or more different types of amine compounds having at least two terminal amino groups. In various embodiments, the polymer is derived from 2, 3, 4, 5, 6, 7, 8, 9 or 10 different types of amine compounds having at least two terminal amino groups.

In various embodiments, the one or more bis-carbonates represented by general formula (2) are selected from the group consisting of succinic bis-carbonate (SuBC), adipic bis-carbonate (ABC), butane diol bis-carbonate (BBC), isomers of pyridine bis-carbonate (PBC1), (PBC2), (PBC3), (PBC4), (PBC5) and (PBC6):

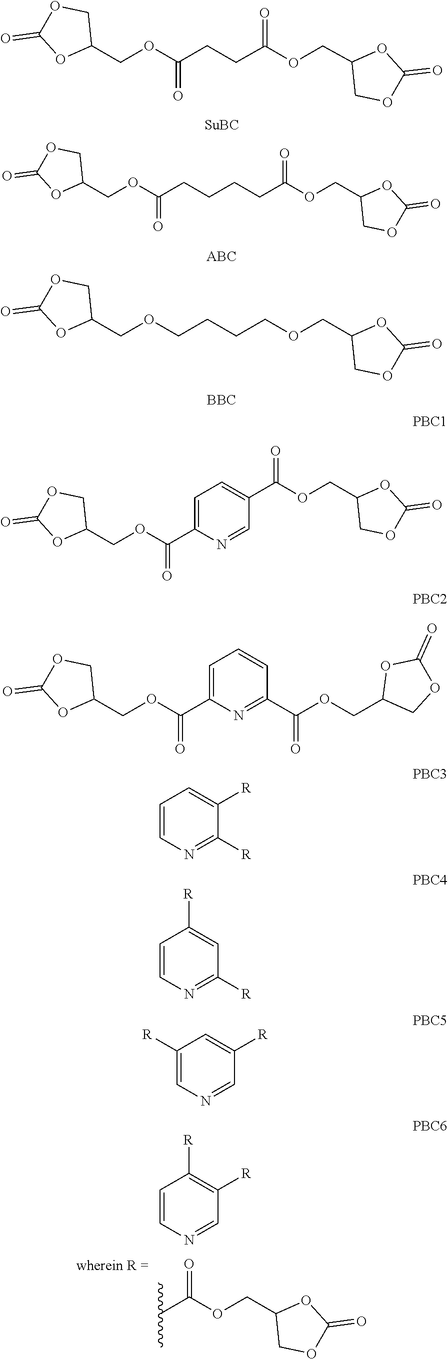

In various embodiments, the bio-carbonates disclosed herein (namely SuBC, ABC, BBC, PBC1, PBC2, PBC3, PBC4, PBC5 and/or PBC6) are/may be obtained/derived from a bio-based source. Advantageously, using such bio-based/derived bis-carbonates as monomers increase the bio-content of polymer, and consequently the biocompatibility of the polymer, making the polymer compatible with biological systems or parts of the biological systems. It will be appreciated that in various embodiments, embodiments of the method disclosed herein may include the use of bio-carbonates that are not obtained/derived from a bio-based source.

In various embodiments, the one or more amine compounds having at least two terminal amino groups represented by general formula (1) are selected from the group consisting of diethylenetriamine (DETA), diamino-N-methyldiethylamine (DMA), triethylenetetramine (TETA), diamino-N-methyldipropylamine (DMPA), pentaethylenehexamine (PEHA), bis(3-aminopropyl)piperazine (BAP), spermine and spermidine:

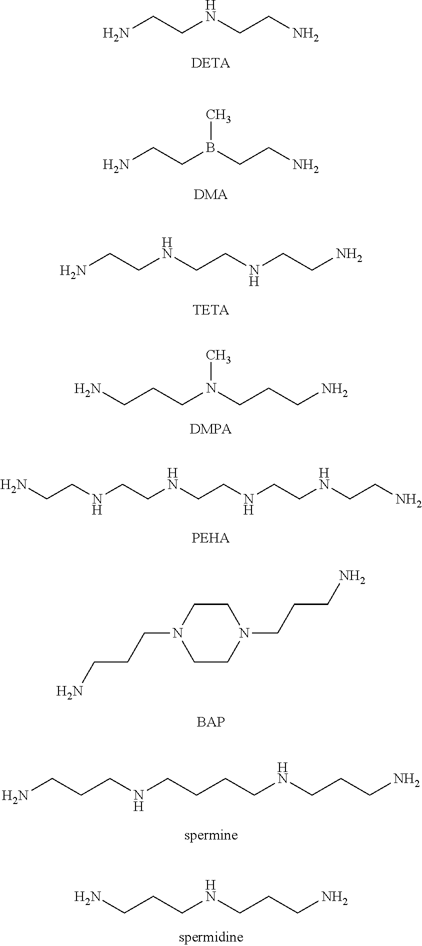

In various embodiments, the one or more amine compounds having at least two terminal amino groups represented by general formula (12) are selected from the group consisting of lysine salt (LyS) and diaminopentane (DAP):

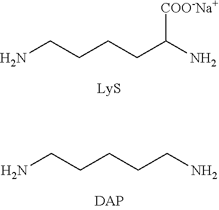

In various embodiments, spermine, spermidine, LyS and/or DAP are obtained/derived from a bio-based source. Advantageously, besides imparting amine functionality to the polymer, the use of such amine compounds disclosed herein further increases the bio-content of the polymer, and consequently the biocompatibility of the polymer, making the polymer compatible with biological systems or parts of the biological systems.

In various embodiments, the polymer is selected from the following:

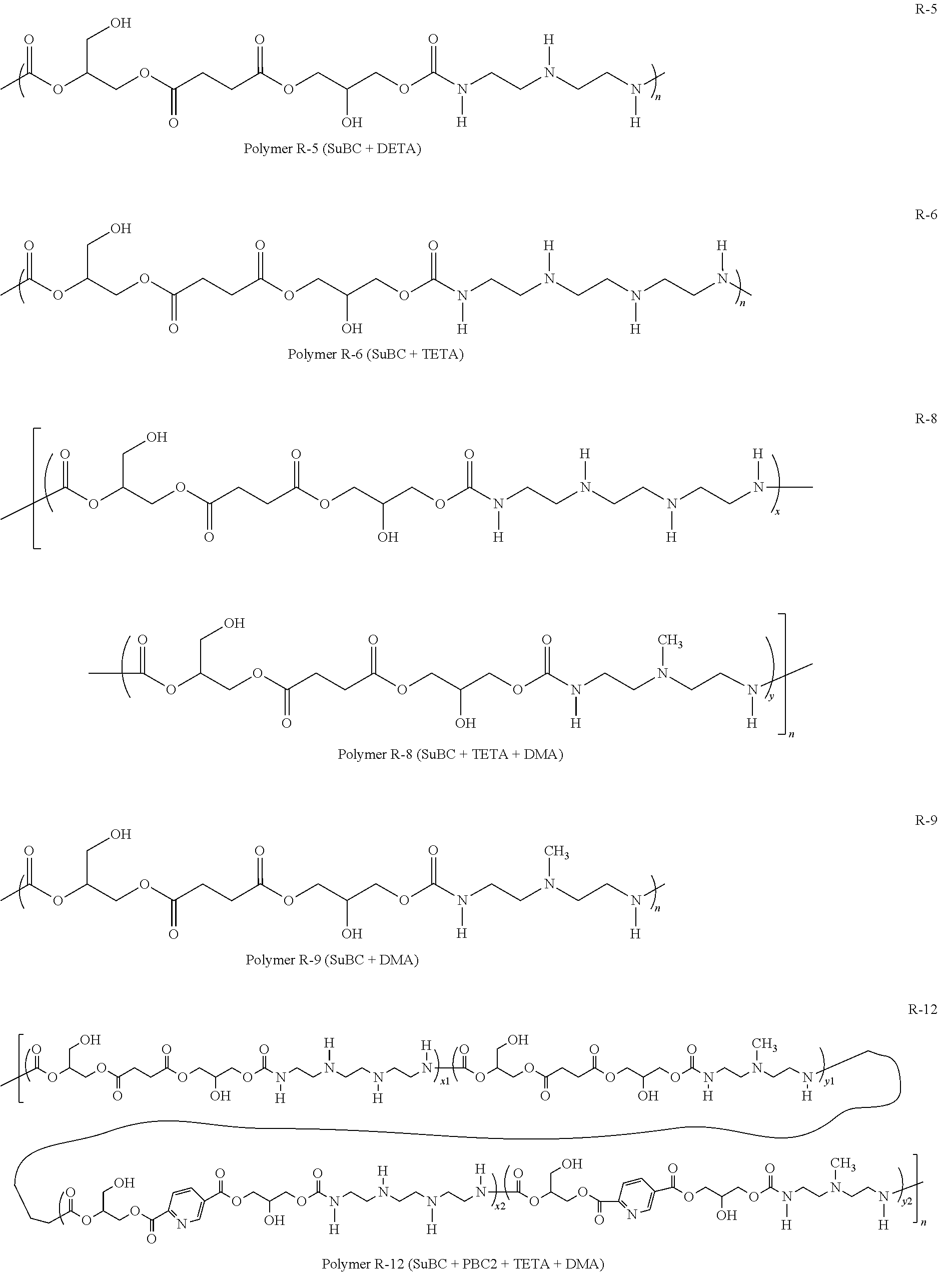

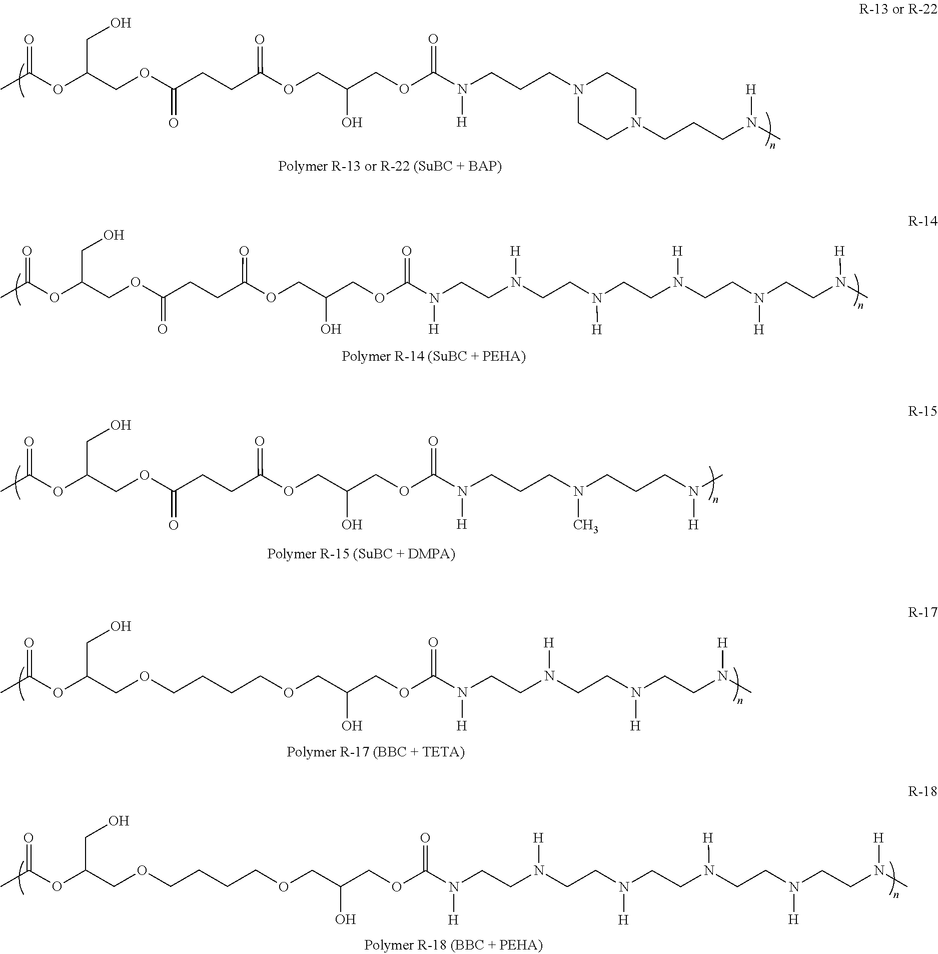

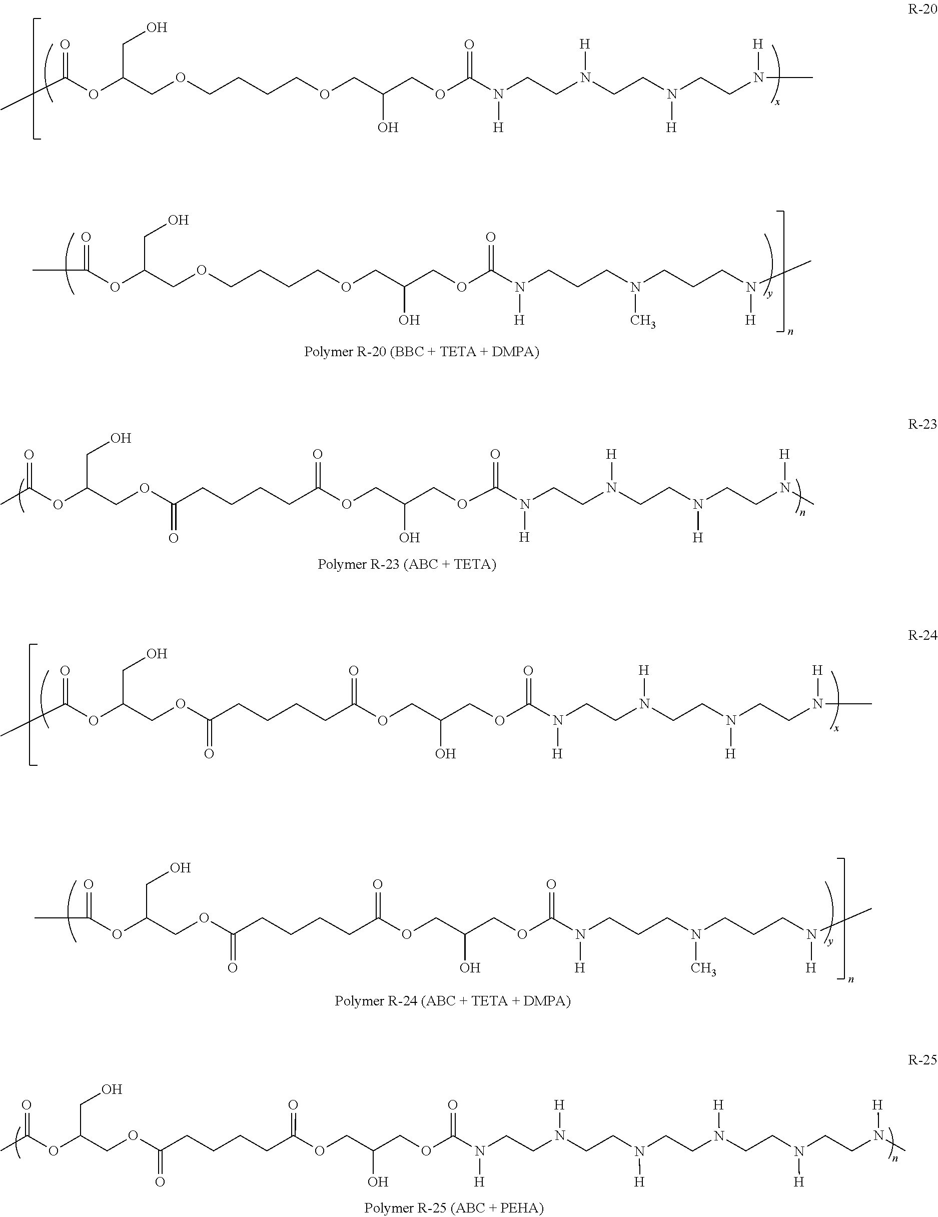

or a derivative thereof, wherein n is an integer that is indicative of the degree of polymerization.

In various embodiments, n≥1. For example, n may be 1, 2, 3, 4, 5, 6, 7, 8, 9, 10, 11, 12, 13, 14, 15, 16, 17, 18, 19, 20, 25, 30, 35, 40, 45, 50, 100, 200, 300, 400, 500 or 1,000.

In various embodiments, the polymer has a glass transition temperature (Tg) of from about −30° C. to about 80° C., from about −25° C. to about 75° C., from about −20° C. to about 70° C., from about −15° C. to about 65° C., from about −10° C. to about 60° C., from about −5° C. to about 55° C., from about 0° C. to about 50° C., from about 5° C. to about 45° C., from about 10° C. to about 40° C., from about 15° C. to about 35° C., from about 20° C. to about 30° C., or about 25° C.

In various embodiments, the polymer has a number average molecular weight (Mn) of from about 500 to about 100,000, from about 1,000 to about 90,000, from about 1,500 to about 80,000, from about 2,000 to about 70,000, from about 2,500 to about 60,000, from about 3,000 to about 50,000, from about 3,500 to about 40,000, from about 4,000 to about 30,000, from about 4,500 to about 20,000, from about 5,000 to about 10,000, from about 5,500 to about 9,500, from about 6,000 to about 9,000, from about 6,500 to about 8,500, from about 7,000 to about 8,000, or about 7,500.

In various embodiments, the polymer has a peak molecular weight (Mp) of from about 500 to about 100,000, from about 1,000 to about 90,000, from about 1,500 to about 80,000, from about 2,000 to about 70,000, from about 2,500 to about 60,000, from about 3,000 to about 50,000, from about 3,500 to about 40,000, from about 4,000 to about 30,000, from about 4,500 to about 20,000, from about 5,000 to about 10,000, from about 5,500 to about 9,500, from about 6,000 to about 9,000, from about 6,500 to about 8,500, from about 7,000 to about 8,000, or about 7,500.

As may be appreciated, the present disclosure also provides a derivative of the polymer/reaction product disclosed above. For example, the derivative may be obtained from functionalizing at least one of a hydroxyl group and an active amine group present in the polymer, or the derivative may be obtained from grafting at least one of a hydroxyl group and an active amine group present in the polymer to another polymer or substrate. In one embodiment, the derivative comprises a functionalized amine derivative and/or a functionalized hydroxyl derivative.

In various embodiments, the polymer further comprises at least one of a hydroxyl group and an active amine group originally present in the polymer that has been functionalised. For example, hydroxyl group(s) and/or active amine group(s) may be functionalized with acrylates (e.g., halogenated acrylates such as fluorinated acrylates) to make hydrophobic anti-bacterial materials. In various embodiments therefore, there is also provided a functionalised product/polymer.

In various embodiments, there is also provided a crosslinked coating/hydrogel/antibacterial polymer (e.g permanently cationic)/antifouling agent/hydrophobic polymer/fluorinated functional polymer/oil-soluble polymer/pour point polymer/pour point depressant/cationic polymer/zwitterionic polymer/anionic polymer/oleophobic polymer/enhanced bio-based polymer with increased bio-content comprising the functionalised product/polymer.

In various embodiments, the polymer is a grafted polymer obtained by grafting the polymer onto another polymer or a substrate. For example, the polymer may be grafted to another polymer or substrate via hydroxyl group(s) and/or active amine group(s) present in the polymer. In various embodiments therefore, there is also provided a grafted product/polymer. The substrate may be a porous and/or solid adsorbent selected from the group consisting of zeolites, metal organic frameworks (MOFs), zeolitic imidazolate frameworks (ZIFs), silica gel, adsorbing porous polymers, carbon, activated carbon and combinations thereof.

In various embodiments, there is also provided use of the polymer as an anti-redepositioning agent, an anti-bacterial agent, an adhesive, an adhesion promoter, a fiber modifier, a pigment dispersant, a chelating agent, a flocculating agent, a wet strength improving additive, a pour point depressant, or a carbon dioxide capture agent.

There is also provided a method of preparing a polymer, the method comprising: polymerizing one or more amine compounds having at least two terminal amino groups represented by general formula (1) with one or more bis-carbonates represented by general formula (2), and optionally one or more amine compounds having at least two terminal amino groups represented by general formula (12):

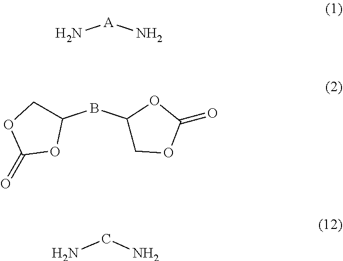

wherein
A comprises a linear aliphatic, branched aliphatic, cyclic and/or aromatic hydrocarbons comprising at least one amine group (e.g., active amine group);
B comprises a linear aliphatic, branched aliphatic, cyclic and/or aromatic hydrocarbons that optionally comprises at least one of an ether, amine, ester and combinations thereof; and
C comprises a linear aliphatic, branched aliphatic, cyclic and/or aromatic hydrocarbons.

In various embodiments, the method comprises a) mixing one or more amine compounds having at least two terminal amino groups represented by general formula (1) with one or more bis-carbonates represented by general formula (2), and optionally one or more amine compounds having at least two terminal amino groups represented by general formula (12) to obtain a reaction mixture; and b) precipitating the polymer.

In various embodiments, the mixing step a) is carried out or undertaken at a temperature of from about 10° C. to about 100° C., from about 15° C. to about 95° C., from about 20° C. to about 90° C., from about 25° C. to about 85° C., from about 30° C. to about 80° C., from about 35° C. to about 75° C., from about 40° C. to about 70° C., from about 45° C. to about 65° C., from about 50° C. to about 60° C., about 55° C., or at room temperature.

In various embodiments, the mixing step a) is carried out or undertaken for a time period of from about 30 mins to about 3 days. The mixing step a) may be carried out for about 30 mins, about 35 mins, about 40 mins, about 45 mins, about 50 mins, about 55 mins, about 60 mins, about 65 mins, about 70 mins, about 75 mins, about 80 mins, about 85 mins, about 90 mins, about 100 mins, about 120 mins, about 3 hours, about 4 hours, about 5 hours, about 6 hours, about 7 hours, about 8 hours, about 9 hours, about 10 hours, about 20 hours, about 24 hours, about 48 hours, or about 72 hours.

In some embodiments, the mixing step a) is carried out in an inert atmosphere or in the absence of oxygen (e.g., by degassing with an inert gas such as nitrogen or argon). In other embodiments, the mixing step a) is carried out in the presence of oxygen (e.g., reaction works in the presence of oxygen).

In various embodiments, the mixing step a) is carried out in the absence of a solvent (e.g. an organic solvent). In various embodiments, the method is substantially devoid of a step containing the use of isocyanates as a reactant. Advantageously, embodiments of the presently disclosed method provide a green and sustainable strategy to produce a polymer having a plurality of active amine groups as use of toxic isocyanates and phosgene are avoided and polymerization may be conducted in the absence of a solvent, i.e. under solvent-less conditions. Embodiments of the method disclosed herein may also be easily scaled up without requiring any specialized external energy input etc. and/or without the production of by-product.

In various embodiments, the method is substantially devoid of a step containing the use of a catalyst. Advantageously, embodiments of the presently disclosed method provide an easy and straightforward strategy to produce a polymer having a plurality of active amine groups as use of catalyst is avoided.

In various embodiments, the mixing step a) is optionally carried out in the presence of an aqueous solution (for e.g., in water) or an organic solvent selected from the group consisting of dimethylformamide (DMF), tetrahydrofuran (THF), 2-methyl tetrahydrofuran, anisole, acetone, dichloromethane (DCM), acetonitrile (ACN), dimethyl sulfoxide (DMSO), γ-valerolactone (GVL), propylene carbonate (PC), dimethylcarbonate (DMC), dioxane, dioxolane, diglyme, acetone, methyl ethyl ketone (MEK), alcohols, esters, ethers, water, sodium hydroxide solution, potassium hydroxide solution and the like and combinations thereof. It is to be appreciated that the type of solvent used is dependent on the type of reactants/monomers used and is not limited to the above.

In various embodiments, the method further comprises one or more post precipitation steps. For example, the method may comprise a step of purifying the polymer formed in the mixture to remove impurities such as excess monomers. The step of purifying the polymer may comprise washing the mixture, filtering the mixture to obtain the polymer and allowing the polymer to dry. The step of washing may be repeated once, twice or thrice. The step of washing may comprise adding a washing medium (e.g., water, diethyl ether). The step of drying may be conducted under vacuum. The step of drying may also be conducted with heat.

In various embodiments, the method further comprises a step of functionalising at least one of a hydroxyl group and an active amine group present in the polymer.

In various embodiments, the method further comprises a step of grafting at least one of a hydroxyl group and an active amine group present in the polymer to another polymer or substrate.

In various embodiments, the step of functionalising and/or grafting comprises nucleophilic addition reactions. In various embodiments, the polymer is functionalized or grafted via nucleophilic addition reactions. The nucleophilic addition reactions may be Aza-Michael addition and/or amine-epoxide addition. Advantageously, in various embodiments, the nucleophilic addition reaction is performed in the absence of catalyst and/or formation of by-products. The nucleophilic addition reaction may also be performed at a temperature of from about 10° C. to about 100° C., from about 15° C. to about 95° C., from about 20° C. to about 90° C., from about 25° C. to about 85° C., from about 30° C. to about 80° C., from about 35° C. to about 75° C., from about 40° C. to about 70° C., from about 45° C. to about 65° C., from about 50° C. to about 60° C., about 55° C., or at room temperature.

In various embodiments, the step of functionalising and/or grafting comprises Aza-Michael addition with α,β-unsaturated carbonyl compounds. For example, by reacting with a suitable α,β-unsaturated carbonyl compound, the polymer may undergoes hydrophobic functionalisation, oleophobic functionalisation, cationic functionalisation, anionic functionalisation and/or zwitterionic functionalisation. The polymer may also be crosslinked/functionalized with acrylates (e.g., bisacrylates such as 1,4-butanediol diacrylate (BDDA) to form a cross-linked coating via Aza-Michael addition. The polymer may also be functionalized with acrylates (e.g., halogenated acrylates such as fluorinated acrylates).

In various embodiments, the step of functionalising and/or grafting comprises amine-epoxide nucleophilic addition with an epoxide or epoxy compounds. For example, the polymer may be crosslinked/functionalized with poly(ethylene glycol) diglycidyl ether (PEGE) to form hydrogels via an amine-epoxide nucleophilic addition.

### BRIEF DESCRIPTION OF FIGURES

FIG. 1 is a schematic diagram 100 showing the application of the polymers designed in accordance with various embodiments (e.g., cationic polymer) as anti-redepositioning agents.

FIG. 2 shows images captured during chelation experiments of polymers designed in accordance with various embodiments disclosed herein with copper salt. The amount of CuBr used is 10 mg and the amount of polymer used is 24 mg. The left most vial contains CuBr in water. Commercial controls are CuBr+PEI in water; and CuBr+PEI-g-PEG in water. Vial Example 1 contains CuBr+Polymer R-14 in water. Vial Example 2 contains CuBr+Polymer R-12 in water. It was observed that formation of blue coloration (in both commercial controls and Vial Examples 1 and 2) was due to the chelation of polymers containing active amine groups with CuBr.

FIG. 3 is a schematic diagram 300 for illustrating an experiment designed for evaluating the potential of using the polymers designed in accordance with various embodiments disclosed herein as anti-redepositioning agents. FIG. 3 also show the images captured during the interaction studies with cotton fiber. The amount of cotton fiber used is 250 mg. It was found that cotton (used as control) contains 42.12% C; 6.01% H and 0.00% N. It was found that modified cotton contains 42.88% C; 6.16% H and 0.07% N.

FIG. 4 shows various types of functionalisation of polymers designed in accordance with various embodiments disclosed herein.

FIG. 5 is a graph showing the biodegradability rate of a polymer prepared from SuBC and TETA (Polymer R-6). The results were obtained from Singapore Test Services and conducted according to Zahn Wellens OECD-302-B. Ethylene glycol was used as a procedure control.

FIG. 6 is a schematic diagram 600 for illustrating an experiment designed for evaluating the CO₂ capture of polymers designed in accordance with various embodiments disclosed herein.

FIG. 7 is a schematic diagram 700 showing the pour point reduction of crude oil or synthetic oil achieved by the usage of a pour point depressant polymer. Pour points were measured on PSL PPT 45150 (ASTM D5985, Rotational method). In various embodiments, the pour point depressant is added up to 1,000 ppm.

FIG. 8 is a graph showing the pour point reduction of wax solutions (i.e. synthetic oil) by N-functionalised polymers prepared from SuBC and PEHA (Polymer R-153 and R-190). Wax A is paraffin wax with melting point of 53-58° C., and Wax C is paraffin wax with melting point of >65° C., purchased from Aldrich (CAS 8002-74-2).

FIG. 9 is a graph showing the rheological effect of N-functionalised polymers prepared from SuBC and PEHA on 10 wt % Wax A solutions in dodecane. As shown, the polymers designed in accordance with various embodiments were able to lower the viscosity by 100 times at 15° C. and the transition temperature for Wax A solution. Wax A is paraffin wax with melting point of 53-58° C.

FIG. 10 is a graph showing the rheological effect of N-functionalised polymers prepared from SuBC and PEHA on 10 wt % Wax A solutions in dodecane. As shown, the polymers designed in accordance with various embodiments were able to lower the storage modulus of Wax A solution by 1000 times at 0.1% shear strain. Wax A is paraffin wax with melting point of 53-58° C.

FIG. 11 shows images captured from experiments designed for evaluating anti-soil redepositioning (ASR) property of polymers designed in accordance with various embodiments disclosed herein on cotton and polyester cloths. The experiments were performed on a polymer prepared from SuBC and PEHA (Polymer R-14).

FIG. 12 shows the colorimetry results obtained from experiments conducted to evaluate anti-soil redepositioning (ASR) property of polymers designed in accordance with various embodiments disclosed herein on cotton and polyester cloths. The experiments were performed on a polymer prepared from SuBC+TETA (Polymer R-6) and SuBC+PEHA (Polymer R-14).

FIG. 13 shows the cell viability results obtained from in-vitro skin irritation test of polymers designed in accordance with various embodiments disclosed herein. The results were obtained from Denova Sciences and conducted in accordance with OECD-TG-439. The experiments were performed on a polymer prepared from SuBC+TETA (Polymer R-6) and SuBC+PEHA (Polymer R-14).

FIG. 14 shows the cell viability results obtained from cytotoxicity test of polymers designed in accordance with various embodiments disclosed herein. The results were obtained from Singapore Polytechnic and conducted using HaCaT Cells. The experiments were performed on a polymer prepared from SuBC+TETA (Polymer R-6) and SuBC+PEHA (Polymer R-14).

FIG. 15 shows images captured and changes in the water contact angle of polymers designed in accordance with various embodiments disclosed herein before and after functionalization. As shown, the water contact angle of a polymer prepared from SuBC+TETA (Polymer R-6) increased from 20° to 104° after functionalization.

### EXAMPLES

Example embodiments of the disclosure will be better understood and readily apparent to one of ordinary skill in the art from the following examples, tables and if applicable, in conjunction with the figures. It should be appreciated that other modifications related to structural, and chemical changes may be made without deviating from the scope of the invention. Example embodiments are not necessarily mutually exclusive as some may be combined with one or more embodiments to form new example embodiments. The example embodiments should not be construed as limiting the scope of the disclosure.

### Example 1: Synthesis of Water Soluble/Dispersible Polymers

A method for the synthesis/construction of novel water soluble/dispersible polymers with tunable (diverse type of aliphatic and aromatic) active amine groups present in the backbone has been developed. Embodiments of the method disclosed herein allow for green synthesis of polymer. The polymer may be synthesized in the presence of water/moisture or in the absence of a solvent, i.e. under solvent-less conditions. Embodiments of the method disclosed herein allow for easy synthesis of polymer without production of by-product(s) and/or in the absence of a catalyst. The polymer may also be synthesized at room temperature. Embodiments of the method disclosed herein may also be easily scaled up without requiring any specialized external energy input etc. and/or without the production of by-product.

The present disclosure provides a strategy to create a new type of amine polymers with tunable structure and properties. Bis-carbonates may be easily copolymerized with amine compounds having at least two terminal amino groups to construct amine polymers. Scheme 1 shows the structures of some examples of monomers that can be used to synthesize water soluble/dispersible polymers with tunable active amine groups present in the backbone.

Scheme 2 shows the synthesis of water soluble succinic acid based active amine polymers from one or more bis-carbonates and one or more amine compounds having at least two terminal amino groups. As shown in Scheme 2, succinic bis-carbonate (SuBC) was used as an example of a bis-carbonate to obtain a water soluble succinic acid based polymer with active amine groups.

Polymers from succinic acid based bis-carbonate (SuBC) with active amine groups were synthesized using the protocol described in Scheme 2. These polymers can be synthesized in different solvents including water, or even in the absence of a solvent, i.e. under a solvent-less condition. Polymerization can be performed at a temperature ranging from room temperature to about 70° C. In various examples, heating the reaction mixture may speed up reaction and/or increase conversion.

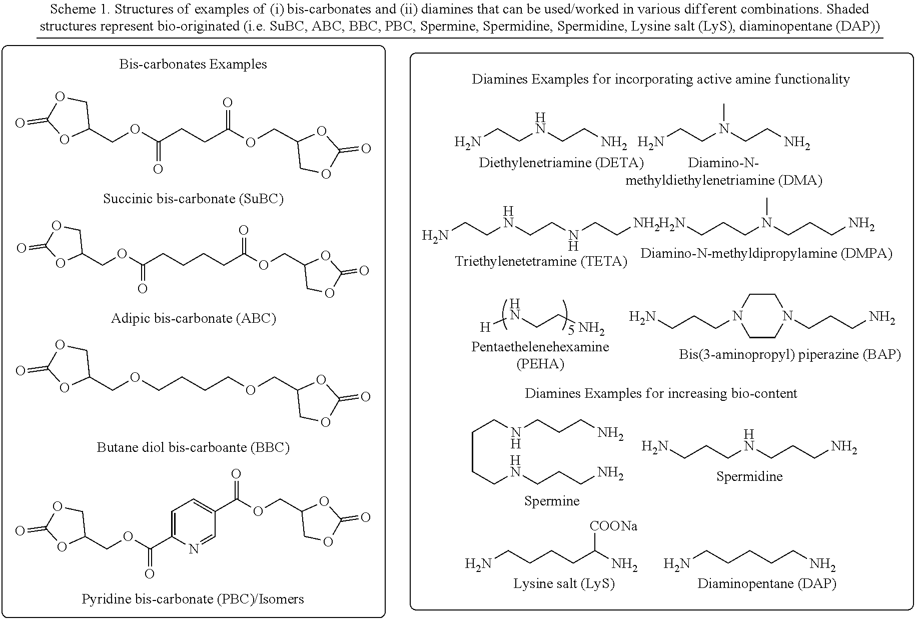

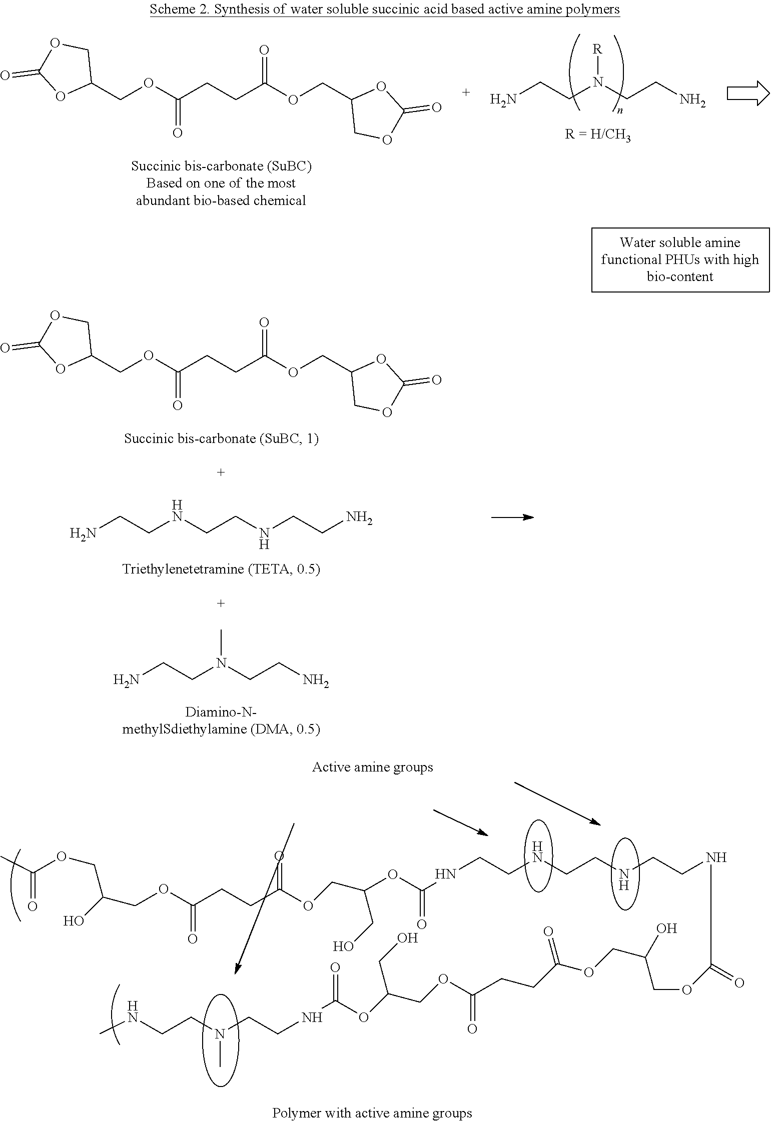

### Example 2: Characterization and Solubility

Polymers obtained were characterized with ¹H & ¹³C NMR spectroscopy, gel permeation chromatography (GPC). Conversion, yield and molecular weight data were reported in Table 1. Table 1 also shows the bio-content of polymers synthesized that usually ranges from 50 to 75% by weight. Most of these polymers are soluble in water (in both acidic and basic pH) unlike traditional polyhydroxyurethanes (PHUs) (Table 2). Without being bound by theory, it is believed that the water solubility of the polymers is mainly attributed to the presence of active amine groups. Bio-content of such polymer could also be increased by the use of amines from natural sources. Polymers from butanediol bis-carbonate (BBC) and adipic acid bis-carbonate (ABC) were also reported in Table 1. Pyridine bis-carbonate (PBC) was an optional monomer useful when targeting to introduce aromatic amine into the polymer structure. R-12 is a representative polymer where all type of amine groups (2°, 3° and aromatic) are present in the backbone.

TABLE 1
Synthesis and characterization of polymers with active amine groups
including approximate bio-content within the polymer. M represents monomers;
Calc represents calculated. Ref: ** N content of commercial control PEI = 22.42%
and N content of PEI-g-PEG = 10.53%

| | | | | | | | | Bio- | |
|---|---|---|---|---|---|---|---|---|---|
| Examples | | | | | | Mₙ | Mₚ | content | |
| (Polymer | M | Conversion at | | Polymer | Tg, DSC | (GPC | (GPC | calc (by | N-content |
| No.) | used | 1 hr | 24 hr | Yield | (° C.) | DMF) | DMF) | w/w) | (E.A.) |
| R-5 | SuBC + | 86% | 95% | 77% | 13.1 | 4720 | 7820 | 63% | 8.45 |
| | DETA | | | | | | | | |
| R-6 | SuBC + | 92% | 97% | 66% | 3.2 | 62450 | 43330 | 57% | 12.45 |
| | TETA | | | | | 1430 | 1460 | | |
| R-8 | SuBC + | 86% | 96% | 73% | −1.8 | 3520 | 2555 | 59% | 9.38 |
| | TETA + | | | | | | | | |
| | DMA | | | | | | | | |
| R-9 | SuBC + | 79% | 96% | 61% | 2.2 | 5760 | 7360 | 61% | 10.12 |
| | DMA | | | | | | | | |
| R-12 | 0.8 | 77% | 94% | 87% | 2.7 | 2130 | 1990 | 49% | 11.39 |
| | SuBC + | | | | | | | | |
| | 0.2 | | | | | | | | |
| | PBC2 + | | | | | | | | |
| | 0.8 | | | | | | | | |
| | TETA + | | | | | | | | |
| | 0.2 | | | | | | | | |
| | DMA | | | | | | | | |
| R-13 | SuBC + | 83% | 96% | 71% | 13.3 | 6040 | 12450 | 67% | 11.03 |
| | BAP | | | | | | | | |
| R-14 | SuBC + | 94% | — | 80% | −3.1 | 2200 | 1730 | 48% | 14.42 |
| | PEHA | | | | | | | | |
| R-15 | SuBC + | 84% | 97% | 88% | −3.7 | 5560 | 9050 | 57% | 9.74 |
| | DMPA | | | | | | | | |
| R-17 | BBC + | 75% | 97% | 86% | −3.6 | 1442 | 976 | 54% | 12.46 |
| | TETA | | | | | | | | |
| R-18 | BBC + | 72% | 80% | 97% | 17.9 | NA | NA | 45% | 15.26 |
| | PEHA | | (1.5 hr) | | | | | | |
| R-20 | BBC + | 68% | 98% | 75% | −6.1 | 5900 | 7280 | 54% | 11.16 |
| | TETA + | | | | | | | | |
| | DMPA | | | | | | | | |
| R-22 | SuBC + | 81% | 98% | 89% | −8 | 7660 | 11730 | 61% | NA |
| | BAP | | | | | | | | |
| R-23 | ABC + | 86% | 96% | 87% | 3.8 | 4760 | 3670 | 59% | 12.04 |
| | TETA | | (6 hr) | | | | | | |
| R-24 | ABC + | 84% | 97% | 73% | 20.1 | 3550 | 3805 | 59% | 9.72 |
| | TETA + | | | | | | | | |
| | DMPA | | | | | | | | |
| R-25 | ABC + | 90% | — | 89% | 5.0 | 1488 | 988 | 51% | 12.87 |
| | PEHA | (rkn | | | | | | | |
| | | stopped) | | | | | | | |

TABLE 2
Solubility of polymers with active amine groups. M represents
monomers.

| Examples | | Water | | | Organic solvent | | | |
|---|---|---|---|---|---|---|---|---|
| (Polymer No.) | M used | pH 4 | pH 7 | pH 9 | DMF | MeOH | THF | Acetone |
| R-5 | SuBC + | ✓ | ✓ | ✓ | [symbol] | [symbol] | X | X |
| | DETA | | | | | | | |
| R-6 | SuBC + | [symbol] | [symbol] | [symbol] | [symbol] | [symbol] | Partial | X |
| | TETA | | | | | | | |
| R-8 | SuBC + | [symbol] | [symbol] | [symbol] | [symbol] | [symbol] | Partial | X |
| | TETA + | | | | | | | |
| | DMA | | | | | | | |
| R-9 | SuBC + | ✓ | ✓ | ✓ | [symbol] | [symbol] | X | X |
| | DMA | | | | | | | |
| R-12 | 0.8 | [symbol] | [symbol] | [symbol] | [symbol] | [symbol] | X | X |
| | SuBC + | | | | | | | |
| | 0.2 | | | | | | | |
| | PBC2 + | | | | | | | |
| | 0.8 | | | | | | | |
| | TETA + | | | | | | | |
| | 0.2 | | | | | | | |
| | DMA | | | | | | | |
| R-13 | SuBC + | ✓ | ✓ | ✓ | [symbol] | [symbol] | X | X |
| | BAP | | | | | | | |
| R-14 | SuBC + | [symbol] | [symbol] | [symbol] | Partial | [symbol] | X | X |
| | PEHA | | | | | | | |
| R-15 | SuBC + | ✓ | ✓ | ✓ | [symbol] | [symbol] | Partial | X |
| | DMPA | | | | | | | |
| R-18 | BBC + | Swell | Swell | Swell | Swell | Swell | X | X |
| | PEHA | → | → | → | | | | |
| | | soluble | soluble | soluble | | | | |
| | | (>3 | (>3 | (>3 | | | | |
| | | days) | days) | days) | | | | |
| R-20 | BBC + | [symbol] | [symbol] | [symbol] | [symbol] | [symbol] | X | X |
| | TETA + | | | | | | | |
| | DMPA | | | | | | | |
| R-22 | SuBC + | Dispersible | Dispersible | Dispersible | [symbol] | [symbol] | [symbol] | Dispersible |
| | BAP | | | | | | | |
| R-23 | ABC + | [symbol] | [symbol] | [symbol] | Swell | [symbol] | X | X |
| | TETA | | | | | | | |
| R-24 | ABC + | [symbol] | [symbol] | [symbol] | [symbol] | [symbol] | X | X |
| | TETA + | | | | | | | |
| | DMPA | | | | | | | |
| R-25 | ABC + | [symbol] | [symbol] | [symbol] | Swell | [symbol] | X | X |
| | PEHA | | | | | | | |

Concentration of polymer solutions were prepared as ~28 mg/mL
✓ = Form clear solution [symbol]
= Form cloudy solution, turns into clear solution after some time

### Example 3: Properties of Water Soluble/Dispersible Polymers

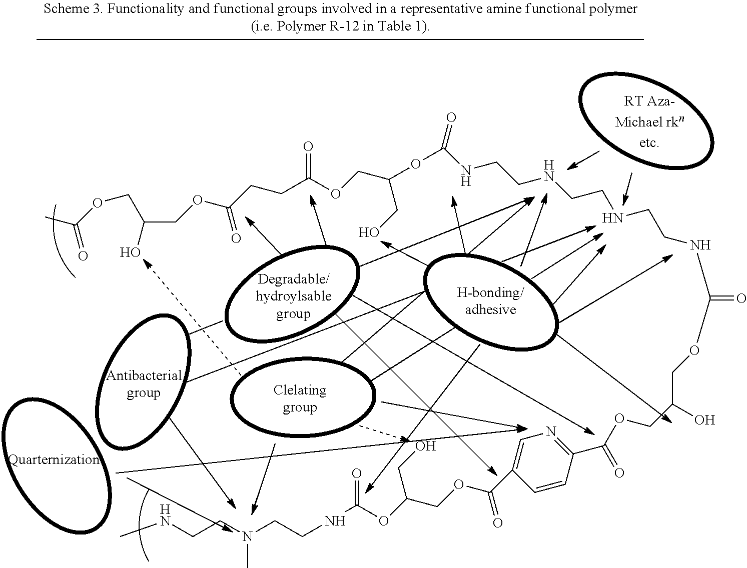

Scheme 3 shows that a polymer designed in accordance with various embodiments disclosed herein can contain ester, urethane, hydroxyl, amine (2°, 3° and aromatic) groups. Amount of bio-content and amine can also be controlled. Such polymers can be crosslinked (using bis-acrylate or bis-epoxy), used to make hydrogel or can also be functionalized with fluorinated acrylates to make hydrophobic antibacterial materials etc.

### Example 4: Functional Properties of Amine Containing Polymers and their Applications

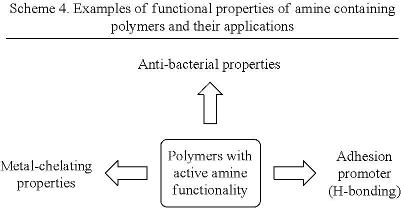

Examples of applications of polymers with active amine functionality include:
(i) Additive to shampoo, detergent and cosmetics (e.g., as antibacterial/anti-redepositioning agent);
(ii) Fibre modification, pigment dispersion, paper industry (e.g., to improve wet strength);
(iii) As an adhesive and/or adhesion promoter;
(iv) Water treatment (e.g., as chelating & flocculating agent) due to metal binding ability;
(v) Carbon dioxide capture; and
(vi) Specialty and high performance applications: in biology for tissue/cell culture (e.g., for improved attachment), drug delivery and transfection agent and in electronics (e.g., to improve photovoltaics performance by reducing work function of indium tin oxide (ITO)/solar cells) etc.
(vii) Oil field applications, pour point depressant

Particularly, the polymer in accordance with various embodiments disclosed herein are useful as additive to laundry products as anti-redepositioning agent, as an adhesive/adhesion promoter, as additive/binder for waterborne coating (e.g., for pigment dispersion and for anti-bacterial formulations).

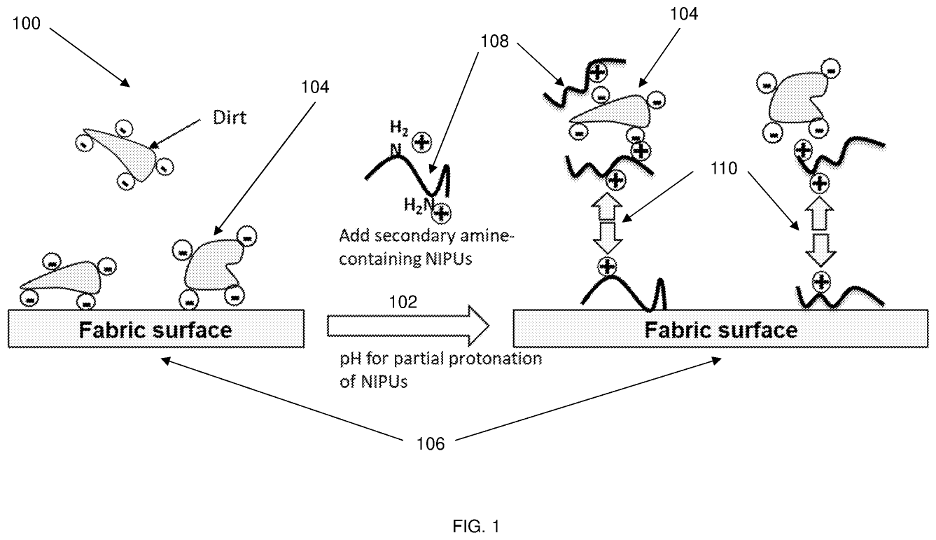

FIG. 1 is a schematic diagram 100 showing the application of cationic polymer as an anti-redepositioning agent.
1) The clay soil 104 redeposit on fabric 106 will lead to whiteness loss of a cloth after washing.
2) Cationic polymer (such as ethoxylated PEI) 108 has been used in detergent to reduce the redeposition of soil particle on textiles.
3) At step 102, the positively charged polymer 108 is adsorbed on negatively charged layers of clay particle 104 and fabric surface 106.
4) This results in repulsive force 110 between the polymer molecules 108 and prevents the redeposition of soil particle on fabrics during a washing cycle, thereby giving a clean fabric.

As shown in FIG. 1, dirt 104 comprising negatively charged particles are deposited on fabric surface 106. By adjusting the pH value at step 102, secondary amine groups (—NH—) present in the polymer gain protons (H⁺) to form positively charged cations (—NH₂⁺—) 108. The positive charge(s) 108 on the polymer allow for embodiments of the polymer to be adsorbed onto the negatively charged particles (e.g., clay or soil particles/deposits) 104 and the fabric surface 106, which results in a repulsive force 110 between the polymer molecules 108 and thereby preventing redeposition of such negatively charged particles during washing.

Amine containing polymers (Scheme 4) are useful for a range of applications such as additive to shampoo, detergent & cosmetics (as antibacterial or redepositioning agent), fibre modification (FIG. 1), pigment dispersion, as adhesive and adhesion promoter, in water treatment (as chelating & flocculating agent), in paper industry (to improve wet strength), carbon dioxide capture etc. High performance applications of such polymers include application in biology for tissue/cell culture (for improved attachment), drug delivery and transfection agent and in electronics (to improve photovoltaics performance by reducing work function of ITO/solar cells) etc. This diverse application of amine polymers are due to the three key chemical properties, namely i) metal-chelation or metal-binding ability, ii) hydrogen-bonding ability and iii) well known anti-bacterial properties of amine functionalities (Scheme 4).

In the following examples, it is shown that the polymer designed/synthesized in accordance with various embodiments disclosed herein can be used for diverse range of specialty applications. The polymers designed in accordance with various embodiments disclosed herein can be synthesized from bio-based monomers (e.g., succinic acid-based monomers) and are easily synthesizable (even in water or bulk) in large quantities. Embodiments of the polymers disclosed herein have also shown/proven to be hydrolysable and are therefore, potentially bio-degradable. Apart from the presence of amine groups, embodiments of the polymers disclosed herein also contain urethane and hydroxyl groups for improved properties and can be further functionalized via catalyst-free room temperature Aza-Michael and amine-epoxy addition reactions for diverse applications. Examples of applications of these polymers include applications as additive (e.g., anti-redepositioning agent) for detergents, cosmetics, as adhesive or adhesion promoter, coatings and as anti-bacterial materials.

### Example 5: Metal (Copper) Coordination/Chelation of Amine Polymers

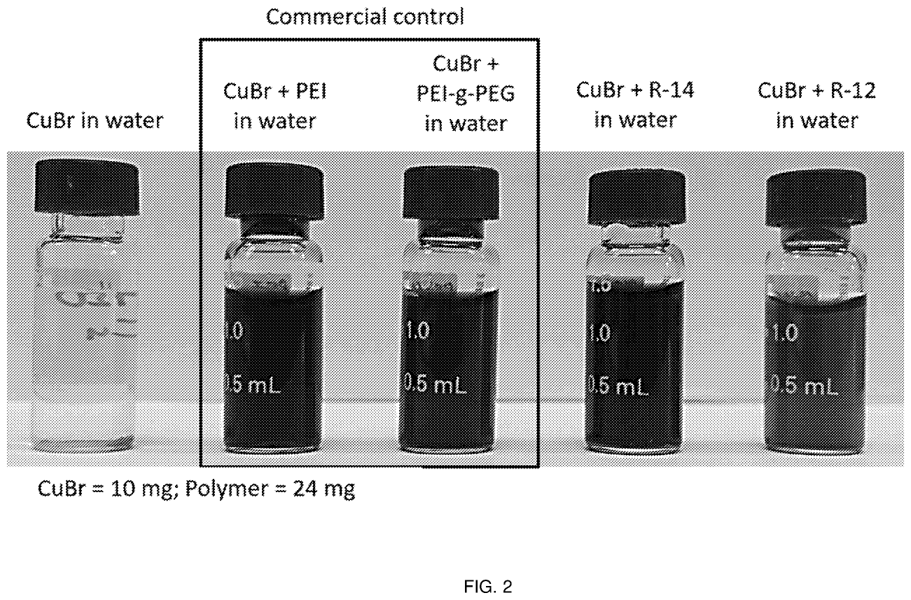

The presence of amine groups of polymers were confirmed by performing chelation experiments with copper salt. Polymers R-12 and R-14 produced characteristic blue coloration when mixed with copper (I) bromide (CuBr) in water (FIG. 2). Industry gold standards PEI-g-PEG and PEI were used as control. Results from the chelation experiments prove the water solubility of the polymers. Results from the chelation experiments also confirm the presence of nitrogen and chelation property of the polymers. It was observed that the polymers helped to dissolve originally insoluble copper salts in water.

### Example 6: Hydrolytic Degradation (Related to Bio-Degradation) of Polymer

Hydrolytic degradability of succinic acid based PHUs designed in accordance with various embodiments disclosed herein were studied initially at pH 10-11 and at elevated temperature (Scheme 5). Degradability of such polymers at lower pH and at room temperature (RT) was also proven to be successful although degradation was slower (at lower pH and at RT). The degraded products were characterized with NMR and GPC. The results are shown in Table 3 below.

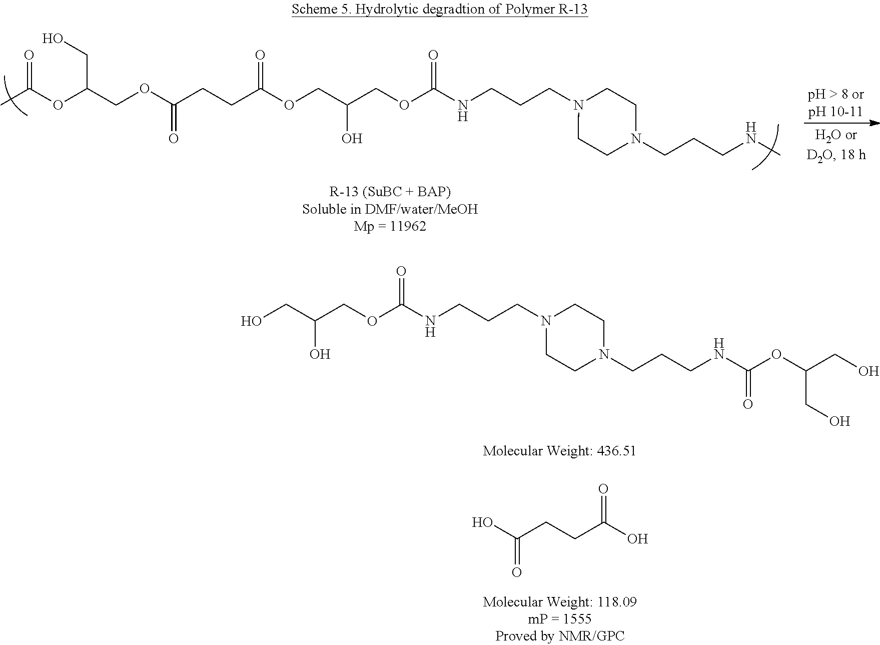

TABLE 3
NMR and GPC results obtained from hydrolytic degradation
experiments performed on Polymers R-13 and R-14
under different reaction conditions.

| | | | Results (GPC, |
|---|---|---|---|
| Polymer | Condition | Results (NMR) | Mp, DMF) |
| R-13 | pH 11 | 86% conversion of | Before: 11960 |
| (SuBC-BAP) | 100° C. | succinate (polymer) to | After: 1560 |
| | 18 hrs | succinic acid after | |
| | | 18 hrs | |
| R-13 | pH 8.4 | 65% conversion of | Before: 10000 |
| (SuBC-BAP) | r.t | succinate (polymer) to | After: 2840 and |
| | 30 days | succinic acid after 30 | 1540 |
| | | days | |
| R-14 | pH 8.4 | ~73% conversion of | — |
| (SuBC-PEHA) | r.t | succinate (polymer) to | |
| | 18 days | succinic acid after 18 | |
| | | days | |

### Example 7: Interaction with Cotton Fiber

A preliminary study aiming to apply the amine containing polymers designed in accordance with various embodiments disclosed herein as anti-redepositioning agent was performed via an interaction study with cotton fiber.

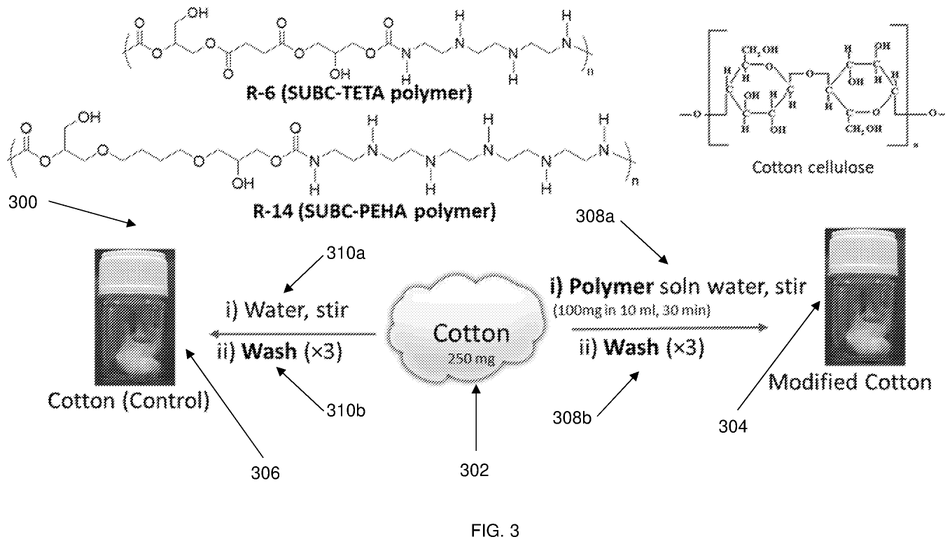

FIG. 3 shows a schematic diagram 300 for illustrating an experiment designed for evaluating the potential of using the polymers designed in accordance with various embodiments disclosed herein as anti-redepositioning agents.

As shown in FIG. 3, at first, at step 308a, cotton fiber 302 (250 mg) was immersed in a polymer solution (100 mg polymer in 10 ml water) and stirred for 30 minutes, and then washed thoroughly several times (e.g., 3 times) at step 308b to remove free polymer. Finally the washed cotton fiber 304 was dried and analyzed with elemental microanalysis to obtain nitrogen (N) content. Presence of elemental N confirmed the cotton fiber-amine polymer interaction. Cotton with no polymer 306 was used as the control. For the control, cotton fiber 302 was immersed in water and stirred at step 310a, and then washed thoroughly several times (e.g., 3 times) at step 310b. No presence of elemental N was detected for the control. Elemental microanalysis results are provided in Table 4.

TABLE 4
Elemental Microanalysis Results

| | Elemental Microanalysis | | |
|---|---|---|---|
| | C | H | N |
| Sample | (% w/w) | (% w/w) | (% w/w) |
| Cotton with no polymer (Control) | 42.35 | 6.07 | Nil |
| Cotton-R6P | 42.49 | 5.99 | 0.10 |
| (Immediately after stirring) | | | |
| Cotton-R6P | 41.99 | 5.94 | 0.00 |
| (After five washes) | | | |
| Cotton-R14P | 42.56 | 6.06 | 0.12 |
| (Immediately after stirring) | | | |
| Cotton-R14P | 43.02 | 6.27 | 0.02 |
| (After five washes) | | | |

### Example 8: Functionalization Reactions

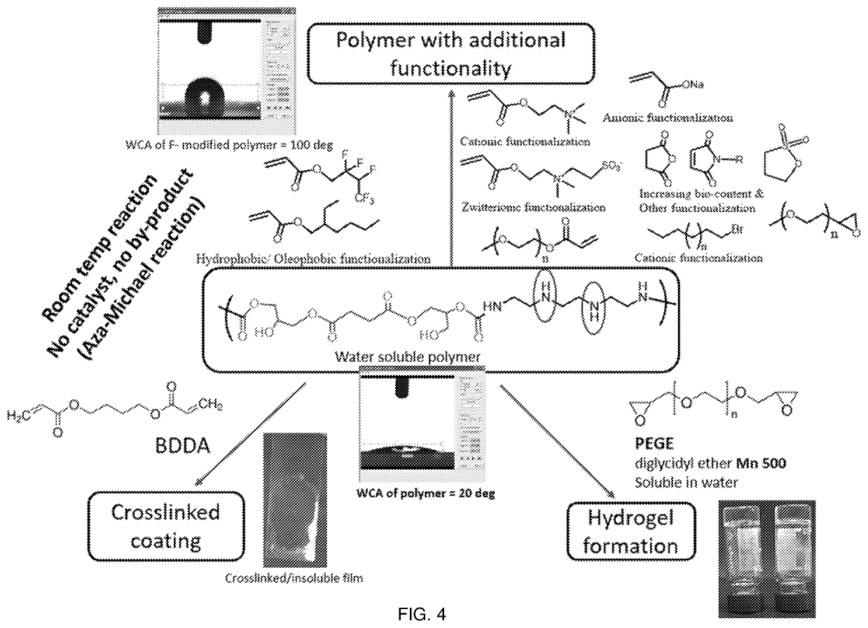

There are numerous possibilities for further functionalization of amine polymers especially from polymer containing secondary —NH— group. As shown in FIG. 4, the water soluble polymers designed in accordance with various embodiments disclosed herein may be further functionalized to produce i) crosslinked coating, ii) hydrogel, iii) permanently cationic antibacterial polymer, iv) introducing antifouling properties, v) hydrophobic properties, vi) increasing bio-content, vii) synthesis of graft polymer etc. by exploiting room temperature atom-efficient Aza-Michael reaction secondary amine group or amine-epoxide nucleophilic addition reaction in the absence of any other reagents or catalysts and/or formation of by-products as depicted in FIG. 4. Examples of functionalization reaction of amine polymers to produce functional materials are also provided in FIG. 4. A few of such functionalized products have been synthesized as shown in the following examples below.

### Example 9: Biodegradability Results of (SuBC+TETA) NIPU

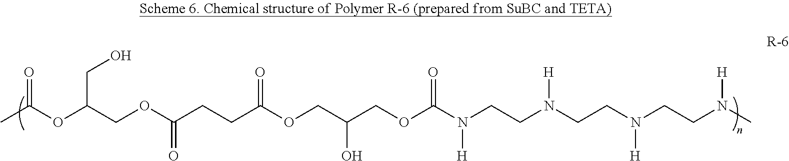

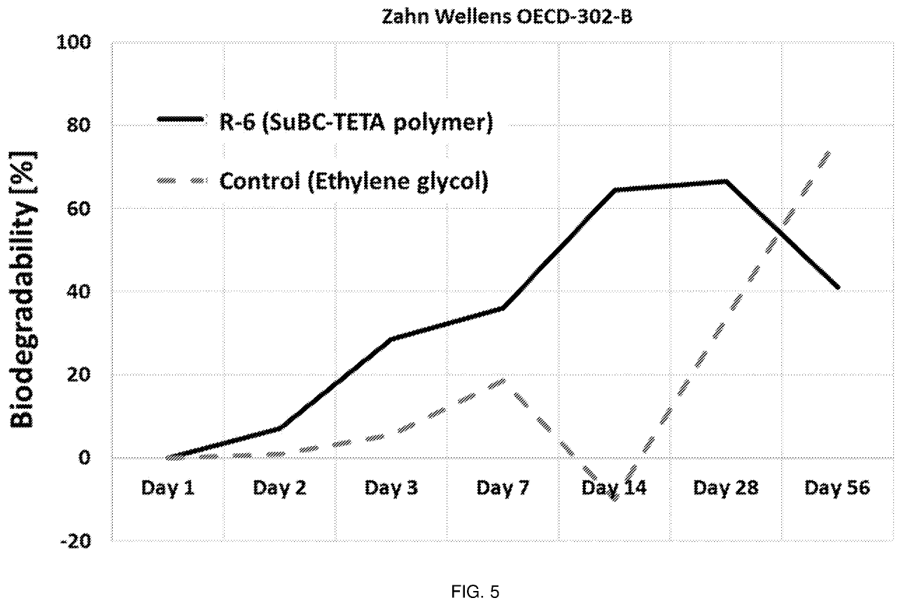

FIG. 5 shows the biodegradability results (Zahn Wellens OECD-302-B) obtained from Singapore Test Services. In this example, Public Utilities Board (PUB)'s activated sludge was extracted from Jurong Water Reclamation Plant and used for investigating the biodegradability of a polymer prepared from SuBC and TETA (Polymer R-6). Total organic carbon was used to determine the remaining carbon materials. Ethylene glycol was used as procedure control which achieved 80% biodegradability rate. SuBC-TETA showed 66% biodegradability after 28 days.

### Example 10: CO₂ Capture Evaluation Results of SuBC+PEHA NIPU

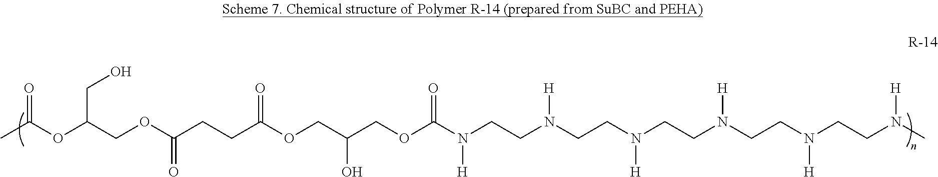

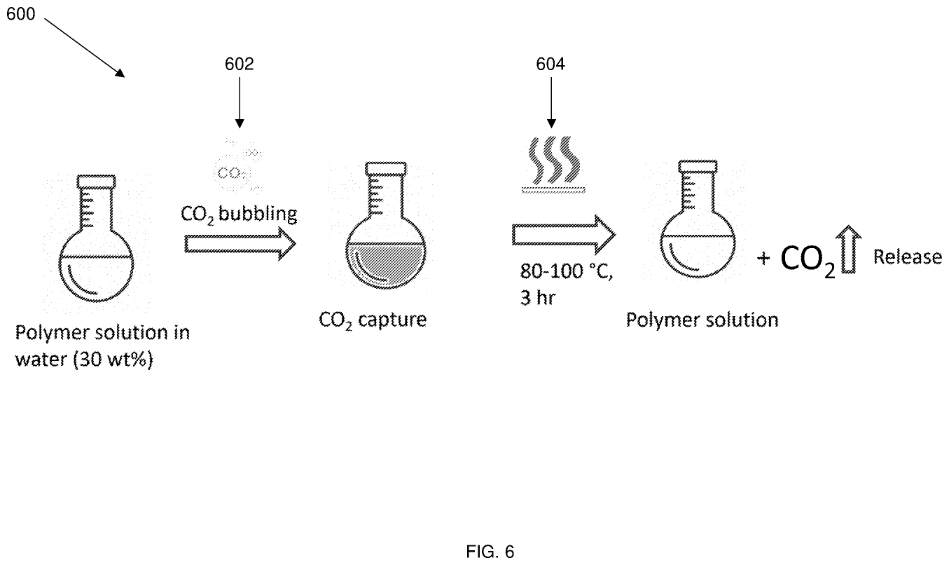

FIG. 6 shows an experimental setup 600 designed to evaluate the CO₂ capture of a polymer prepared from SuBC and PEHA. A polymer solution of 30% by weight in water was prepared, in which CO₂ was bubbled through at step 602 to facilitate CO₂ capture. The polymer solution was then heated at a temperature of 80° C. to 100° C. over 3 hours at step 604, and monitored for CO₂ release.

Results obtained from CO₂ capture experiments are provided in Table 5.

TABLE 5
CO₂ capture evaluation results of SUBC + PEHA NIPU

| | Weight gain (g) | g of | g of |
|---|---|---|---|
| | after CO₂ | CO₂/g | CO₂/Mole |
| | bubbling | of solution | of amines |
| DI water | 0.011 g | 0.003 g | NA |
| Monoethanolamine, MEA | 0.307 g | 0.130 g | 18.7 |
| (commercial benchmark)- | | | |
| 30 wt. % | | | |
| SuBC-PEHA -30 wt. % | 0.062 g | 0.030 g | 8.58 |

The CO₂ capture evaluation results suggest that SuBC-PEHA could be a non-toxic, non-volatile CO₂ capture material and can be used as a replacement of well known CO₂ capture small molecular weight/volatile/toxic chemical monoethanolamine (MEA).
SuBC-PEHA showed promising carbon dioxide capture property
SuBC-PEHA required lower temperature for CO₂ release, while MEA required >120° C.
The CO₂ capture evaluation results show that SuBC-PEHA has potential to be grafted on other solid porous substrates like silica, zeolite, metal-organic frameworks (MOF) etc. to be useful for solid state CO₂ capture material.

### Example 11: Pour Point Reduction of Crude Oil/Synthetic Oil

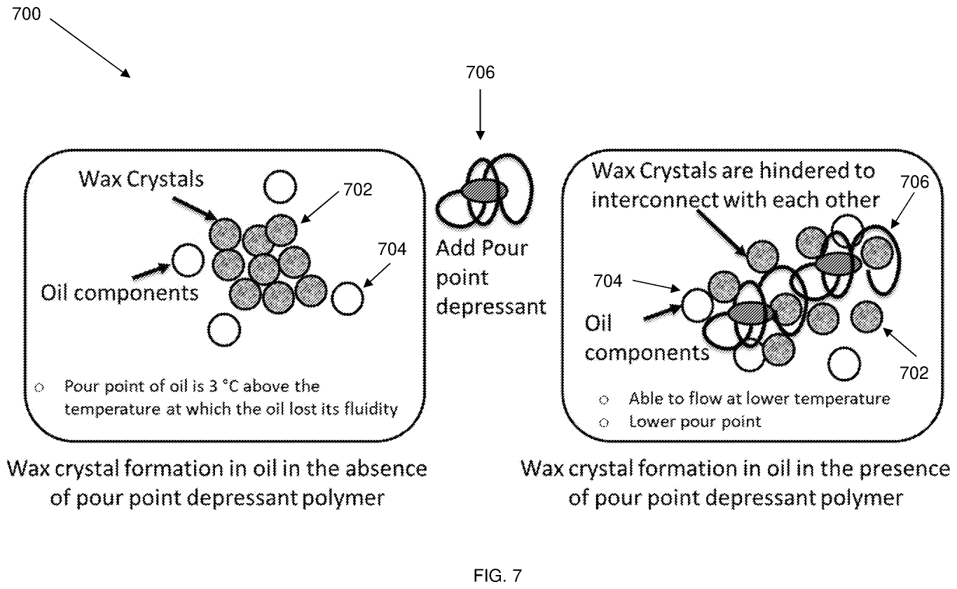

FIG. 7 is a schematic diagram 700 showing pour point reduction of crude oil or synthetic oil achieved by the usage of a pour point depressant polymer. Pour points were measured on PSL PPT 45150 (ASTM D5985, Rotational method). The wax crystals 702 and oil components 704 within the crude oil or synthetic oil is arranged in an orderly manner at the pour point of the oil, which has a temperature that is about 3° C. above the temperature at which the oil lost its fluidity. Upon addition of the pour point depressant 706 up to the concentration of 1000 ppm, it was observed that the pour point of the oil is lowered and the oil is able to flow at a lower temperature as the wax crystals 702 are now hindered in their interconnection, resulting in a disorderly arrangement.

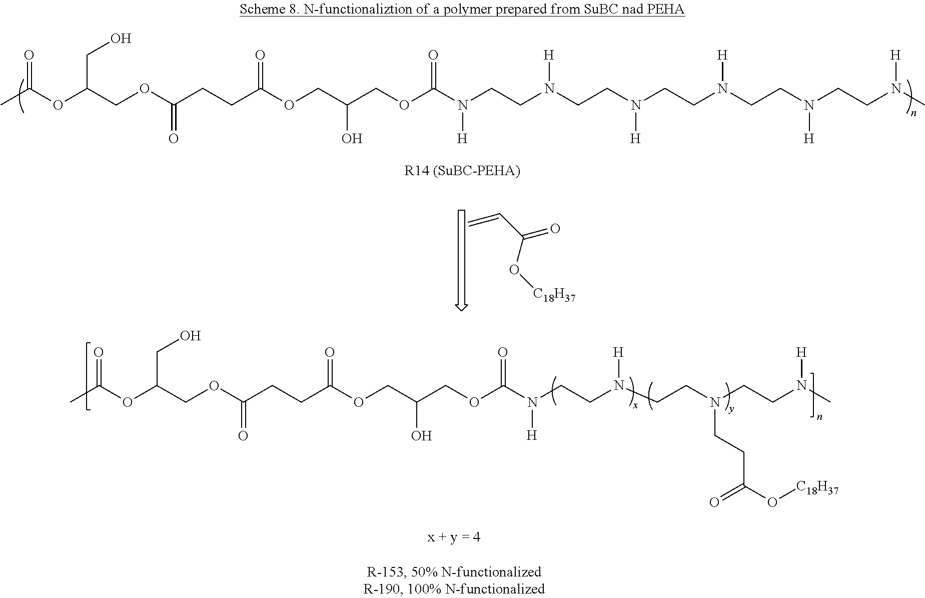

N-functionalized polymers R-153 and R-190 which are oil/dodecane soluble, were synthesized according to Scheme 8. In R-153, 50% N-functionalization was achieved, whereby it contains 50% C₁₈H₃₇ by formula. In R-190, 100% N-functionalization was achieved, whereby it contains 100% C₁₈H₃₇ by formula.

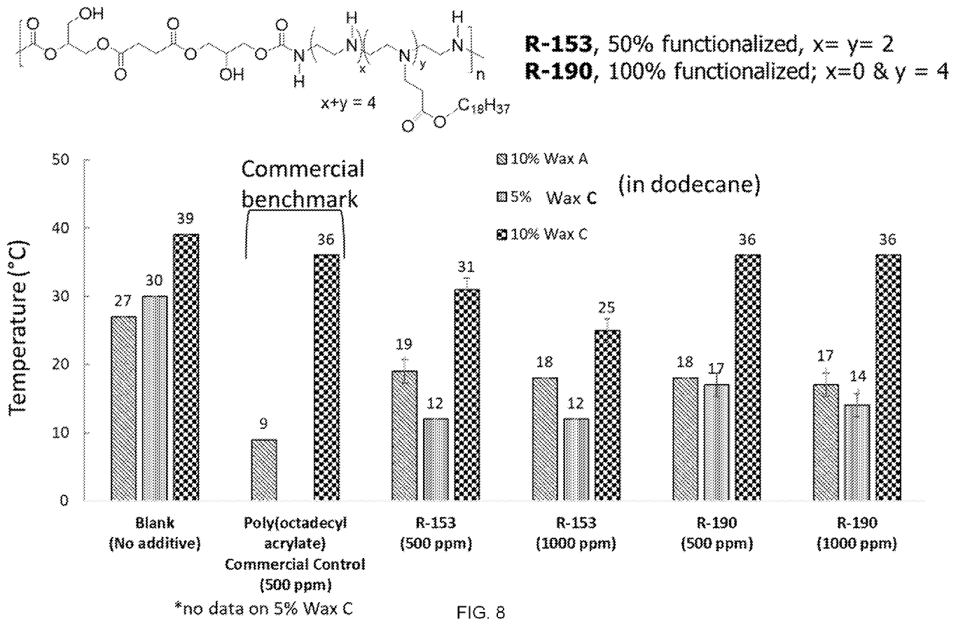

The evaluation of pour point reduction on wax solutions by N-functionalised SuBC+PEHA NIPUs R-153 and R-190 are shown in FIG. 8. The N-Functionalized SuBC-PEHA NIPUs are able to reduce pour point of wax solution (synthetic oil) up to 18° C., which showed promising pour point depressant (PPD) property as compared to commercial benchmark, i.e. poly(octadecyl acrylate).

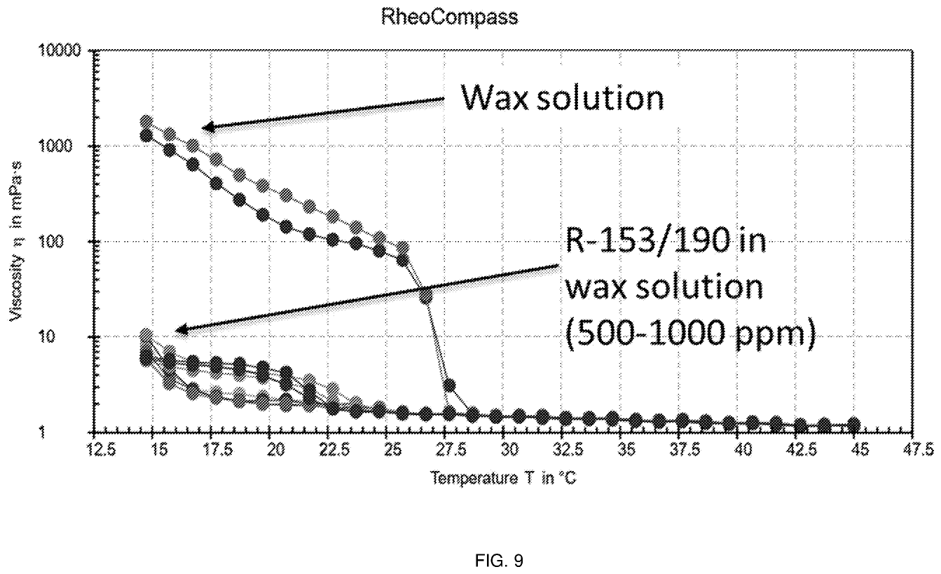

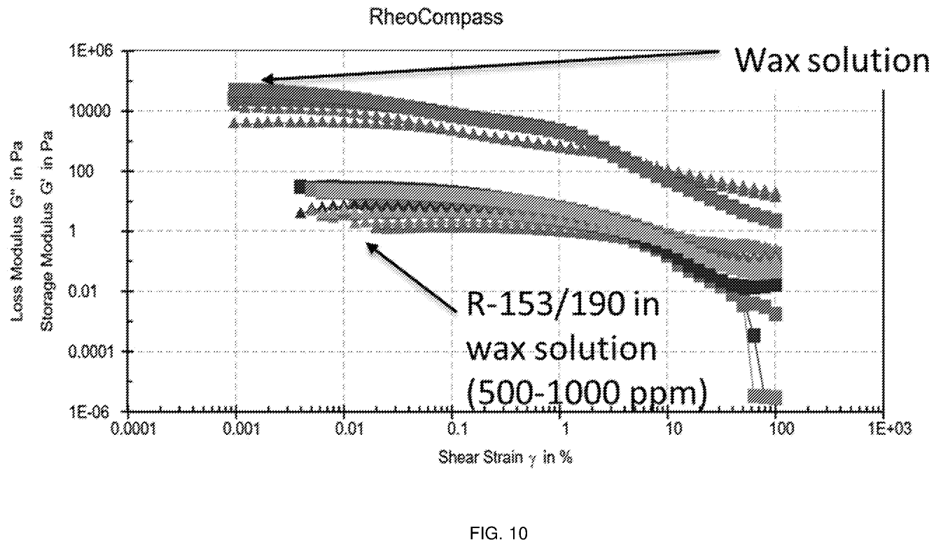

The rheological effects of NIPU on 10 wt % Wax A solution in dodecane are shown in FIG. 9 and FIG. 10. From FIG. 9, the N-functionalised SuBC+PEHA NIPUs R-153 and R-190 having a concentration of 500 ppm were able to lower the viscosity by 100 times at 15° C. and the transition temperature for Wax A solution. From FIG. 10, the N-functionalised SuBC+PEHA NIPUs R-153 and R-190 having a concentration of 500 ppm were able to lower the storage modulus of Wax A solution by approximately 1000 times at 0.1% shear strain. Without being bound by theory, it is believed that lower storage modules are due to lower viscosity, less stiff and less energy stored.

### Example 12: Anti-Soil Redepositioning (ASR) Property

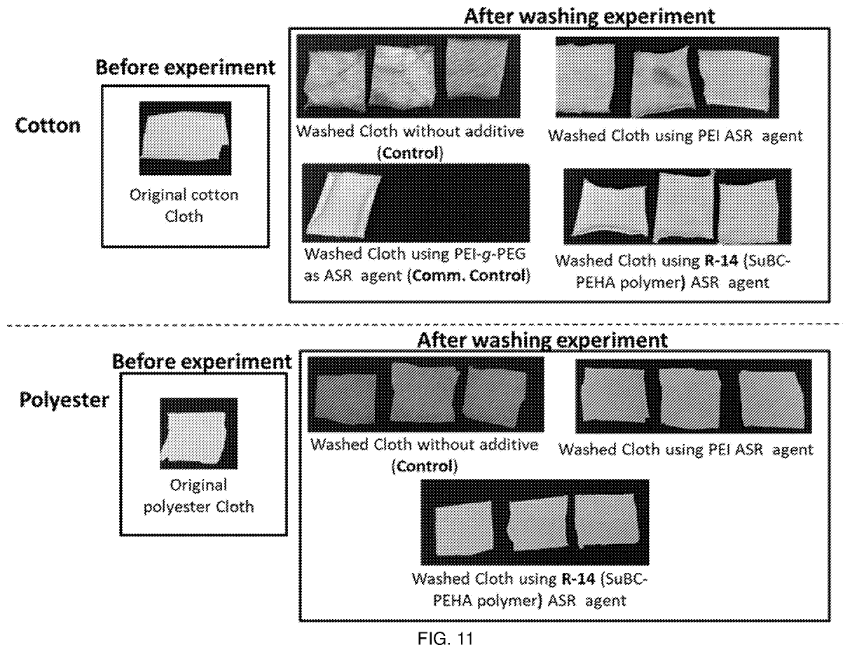

The anti-soil redepositioning (ASR) property of the polymers designed in accordance with various embodiments disclosed herein on cotton and polyester cloths were evaluated. Both cotton and polyester cloths were washed in SuBC-PEHA ASR agent, PEI ASR agent and without additives as a control. Cotton cloth was additionally washed using PEI-g-PEG as ASR agent as a commercial control. Images were captured before and after the washing experiment and shown in FIG. 11. From the washing experiment, the synthesized NIPU SuBC-PEHA showed good anti-soil redeposition property on both cotton and polyester cloths.

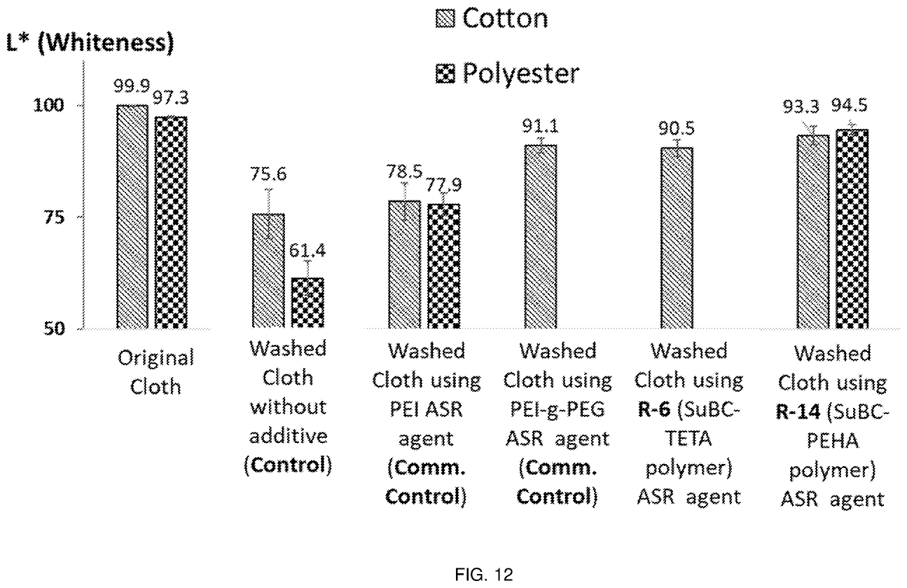

FIG. 12 shows the colorimetry results obtained for the washing experiments for a quantitative analysis of the ASR property of SuBC-PEHA and SuBC-TETA on the cotton and polyester cloths. The synthesized NIPUs SuBC-PEHA and SuBC-TETA showed very good anti-soil redeposition property on both cotton and polyester cloths. Similar performance was observed for the commercially used but expensive ASR agent, PEI-g-PEG.

### Example 13: Skin Irritation and Cytotoxicity Results of SuBC+TETA and SuBC+PEHA

Cell viability experiments were conducted on polymers designed in accordance with various embodiments.

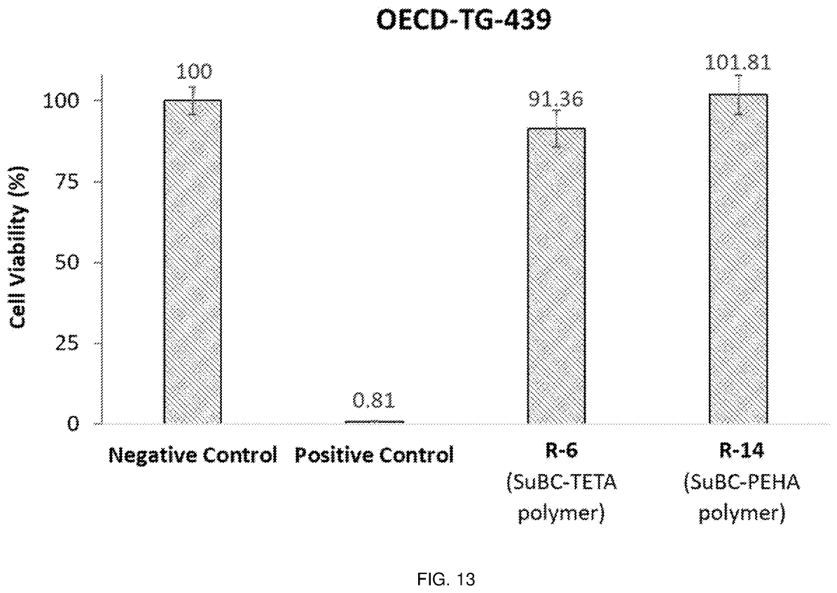

FIG. 13 shows the cell viability results obtained from in-vitro skin irritation test of polymers designed in accordance with various embodiments disclosed herein. The results were obtained from Denova Sciences and conducted in accordance with OECD-TG-439. The experiments were performed on a polymer prepared from SuBC+TETA (Polymer R-6) and SuBC+PEHA (Polymer R-14).

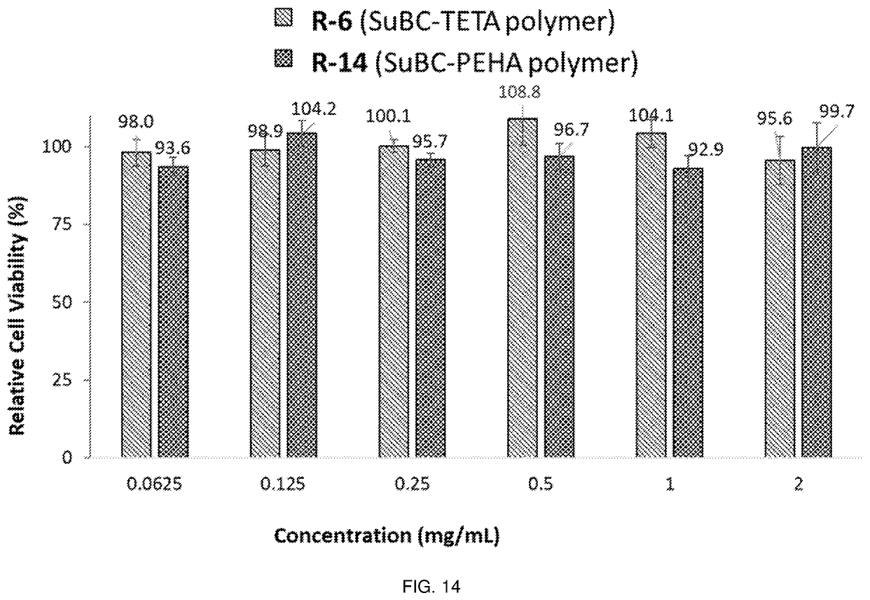

FIG. 14 shows the cell viability results obtained from cytotoxicity test of polymers designed in accordance with various embodiments disclosed herein. The results were obtained from Singapore Polytechnic and conducted using HaCaT Cells. The experiments were performed on a polymer prepared from SuBC+TETA (Polymer R-6) and SuBC+PEHA (Polymer R-14).

Both SuBC-TETA and SuBC-PEHA were proved to be non-skin irritant and non-cytotoxic.

### Example 14: Easy Post-Functionalization of Sec-Amine Containing NIPUs to Improve Functional Properties

As shown in Scheme 9, secondary-amine containing NIPUs designed in accordance with various embodiments disclosed herein can be easily post-functionalized for improvement in functional properties. SuBC-TETA or SuBC-PEHA can be post-functionalized into SuBC-TETA-EH, SuBC-PEHA-EH, SuBC-PEHA-Sy or SuBC-TETA-HF, when reacted with 2-ethylhexyl acrylate, stearyl acrylate or hexafluorobutyl acrylate respectively.

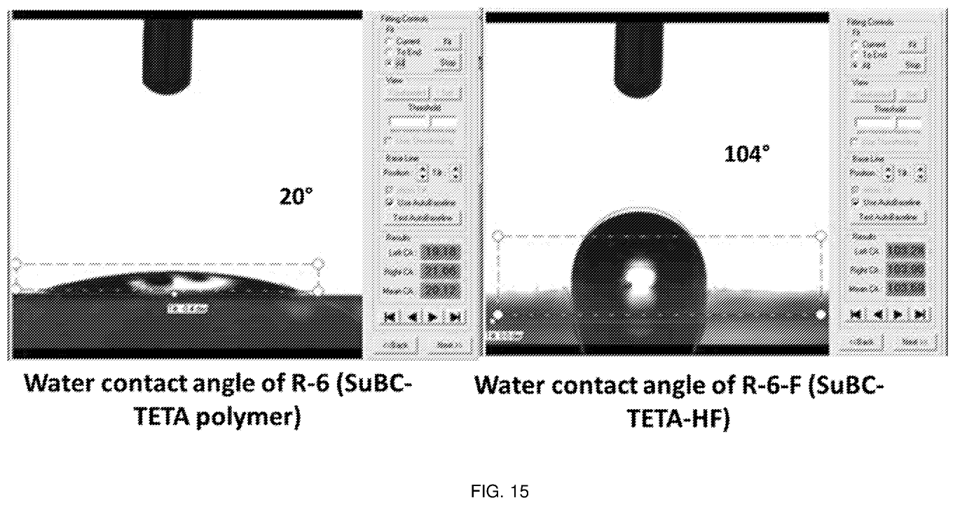

Scheme 9 shows a specific post-functionalization procedure, whereby SuBC-TETA is reacted with hexafluorobutyl acrylate with DMF or DMSO to obtained SuBC-TETA-HF. The change in water contact angle which represents change in coating surface property was measured to determine the success in post-functionalization. From FIG. 15, it was shown that the water contact angle of SuBC-TETA was 20° before functionalization, and after functionalization of SuBC-TETA into SuBC-TETA-HF, the water contact angle was increased to 104°.

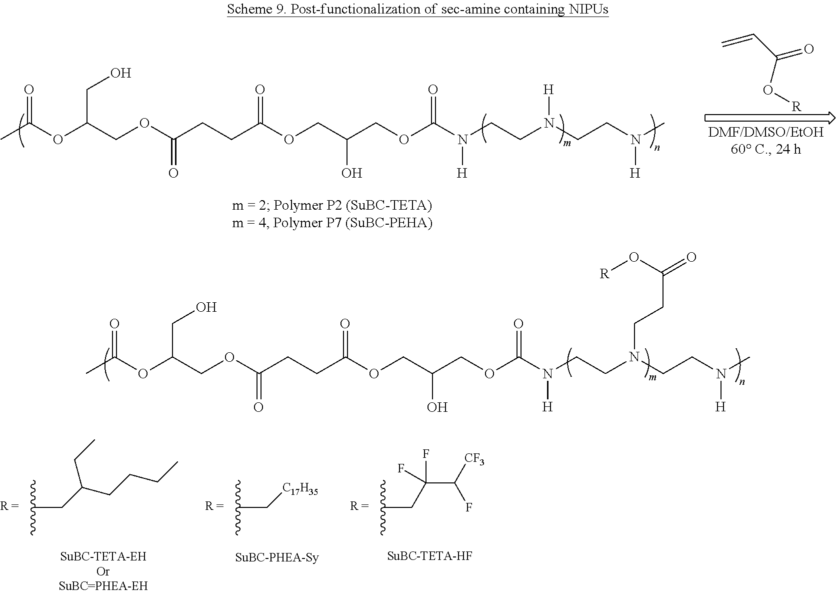

### Example 15: Materials and Methods

### i) Synthesis of Succinic Bis-Carbonate (SuBC)

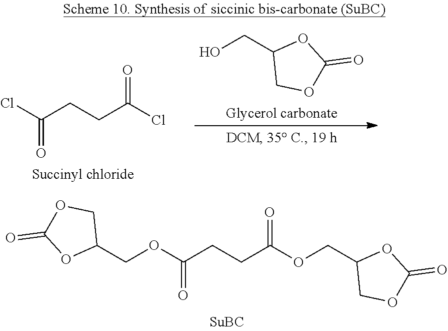 [SMILES: O=C(Cl)CCC(=O)Cl ; O=C1OCC(CO)O1 ; O=C(CCC(=O)OCC1COC(=O)O1)OCC1COC(=O)O1]

Succinyl chloride (20 g, 129 mmol) was added slowly to dichloromethane (DCM) (100 mL) in a round bottom flask under nitrogen atmosphere. Glycerol carbonate (32 g, 271 mmol) was added dropwise to the succinyl chloride solution at 0° C. After addition, the reaction mixture was stirred at 35° C. under nitrogen atmosphere for 19 hrs. The precipitated solid was washed with 1 M NaOH solution (85 mL) followed by water (100 mL×2). The solid was dried partially and washed with cold acetone. The white solid was dried under vacuum at 50° C. for overnight and used for polymerization without further purification (27.5 g, yield 67%). ¹H NMR (400 MHz, DMSO) δ 5.03 (m, 2H), 4.56 (t, 2H), 4.27 (m, 6H), 2.62 (s, 4H). ¹³C NMR (101 MHz, DMSO) δ 171.69, 154.81, 74.33, 66.04, 63.66, 28.48.

### ii) Synthesis of Adipic Bis-Carbonate (ABC)

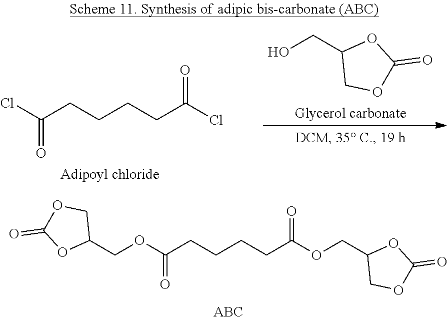 [SMILES: O=C(Cl)CCCCC(=O)Cl ; O=C1OCC(CO)O1 ; O=C(CCCCC(=O)OCC1COC(=O)O1)OCC1COC(=O)O1]

Adipoyl chloride (8 g, 43.7 mmol) was added slowly to dichloromethane (32 mL) in a round bottom flask under nitrogen atmosphere. Glycerol carbonate (10.8 g, 91.4 mmol) was added dropwise to the adipoyl chloride solution at 0° C. After addition, the reaction mixture was stirred at 35° C. under nitrogen atmosphere for 19 hrs. The reaction mixture was diluted with dichloromethane (40 mL), and washed with 1 M NaOH solution (15 mL) followed by water (15 mL) and brine (6 mL). The organic phase was dried over anhydrous magnesium sulfate, filtered, and concentrated under reduced pressure to obtain a viscous liquid, which slowly crystallized into white solid. The white solid was dried under vacuum at 50° C. for overnight and used for polymerization without further purification (12.3 g, yield 81%). ¹H NMR (400 MHz, DMSO) δ 5.02 (m, 2H), 4.56 (t, 2H), 4.25 (m, 6H), 2.36 (m, 4H), 1.54 (m, 4H). ¹³C NMR (101 MHz, DMSO) δ 172.31, 154.63, 74.22, 65.97, 63.25, 32.80, 23.58.

iii) Synthesis of Butanediol Bis-Carbonate (BBC)

The bis-epoxy product 1,4-bis(oxiran-2-ylmethoxy)butane (10 mmol, 2.02 g), tetrabutyl ammonium iodide (TBAI) (5 mol %, 185 mg, 0.5 mmol) and pyridinedimethanol (5 mol %, 70 mg, 0.5 mmol) were dissolved in 20 mL of dry tetrahydrofuran (THF), transferred into a Parr reactor and pressurized with CO₂ up to 180 psig after purging with N₂. The reaction was carried out under stirring at 105° C. for 24 h. After the reaction, the reactor was cooled to room temperature and depressurized. The solvent THF was removed and redissolved in 50 ml diethyl ether, and the product was precipitated from 30 mL petroleum ether. 1.8 g (63%) of the product was obtained as off white solid. ¹H NMR (400 MHz, Chloroform-d) δ 4.84-4.76 (m, 2H), 4.49 (t, J=8.3 Hz, 2H), 4.42-4.35 (m, 2H), 3.74-3.56 (m, 4H), 3.53 (t, J=4.8 Hz, 4H), 1.69-1.61 (m, 4H).

iv) An Example of Polymerization Procedure of SuBC with TETA at High Temperature

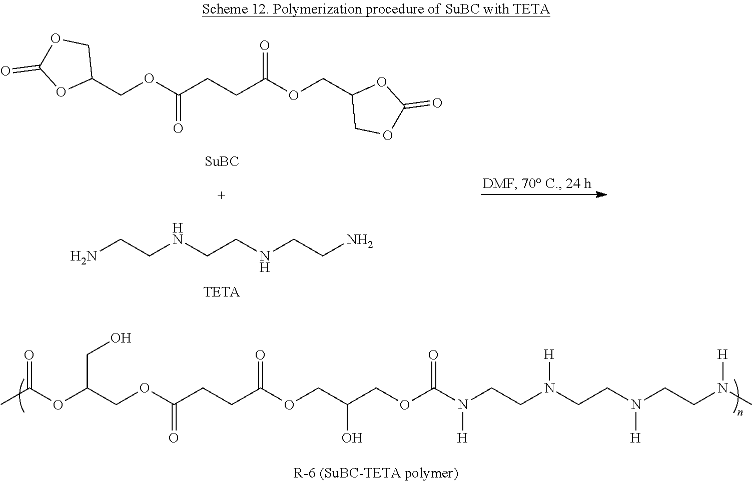

SuBC (0.5 g, 1.57 mmol) and triethylenetetramine (TETA, 0.23 g, 1.57 mmol) were added into a reaction vial charged with magnetic stirring bar. A few drops of mesitylene were added as internal reference. Dimethylformamide (DMF) (1 mL) was added and the reaction mixture was degassed with nitrogen under stirring. After 15 minutes, the reaction mixture was stirred at 70° C. for 24 hours. The reaction mixture was added into diethyl ether to precipitate the polymer. The precipitated polymer (R-6, SuBC-TETA polymer) was washed with diethyl ether for three times followed by drying under vacuum at 60° C. for overnight (0.48 g, yield 66%). ¹H NMR (400 MHz, DMSO) δ 7.05 (br, 2H), 5.07-4.70 (br, 1H), 4.12 (br, 2H), 4.05-3.84 (br, 6H), 3.77 (br, 1H), 3.42 (br, 4H), 2.98 (br, 4H), 2.49 (br, 12H).

### v) An Example of Polymerization Procedure of SuBC and PEHA at Room Temperature

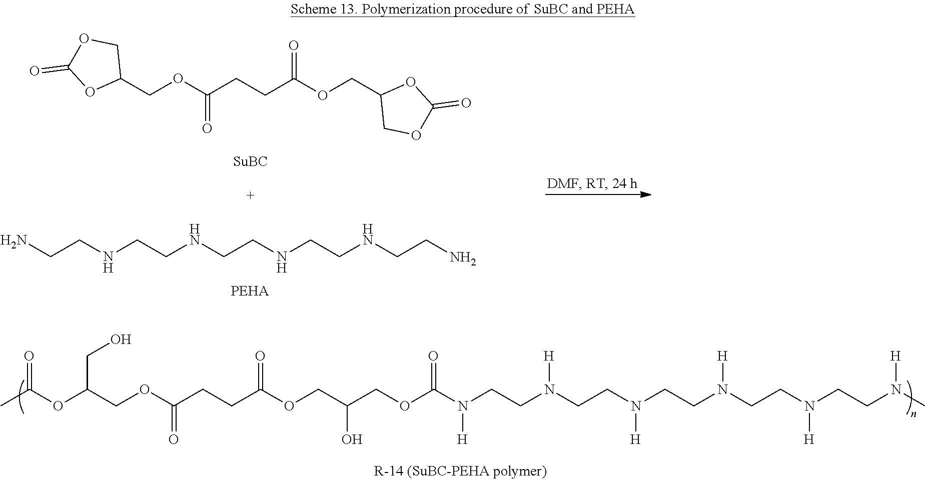

SuBC (0.25 g, 0.79 mmol) and DMF (1 mL) were added into a reaction vial charged with magnetic stirring bar. A few drops of mesitylene were added as internal reference. Pentaethylenehexamine (PEHA, 0.183 g, 0.79 mmol) was added and the reaction mixture was degassed with nitrogen under stirring. After 15 minutes, the reaction mixture was stirred at room temperature for 24 hours. The reaction mixture was added into diethyl ether to precipitate the polymer. The precipitated polymer was washed with diethyl ether for three times followed by drying under vacuum at 60° C. for overnight (0.3 g, yield 69%). ¹H NMR (400 MHz, DMSO) δ 7.06 (br, 2H), 4.97 (br, 1H), 4.83 (br, 1H), 4.72 (br, 1H), 4.16-4.02 (br, 2H), 3.97-3.85 (br, 4H), 3.77 (br, 1H), 3.00 (br, 5H), 2.55-2.50 (br, 14H), 2.27 (br, 5H).

### vi) NIPU Hydrogel Formation

The NIPU solution was prepared by dissolving SUBC-TETA polymer (R-6,150 mg) in deionized water (0.75 mL). This NIPU solution was separated into three separate vials (0.25 mL each, 0.2 mmol based on mole of TETA), namely, Control, Sample 1 and Sample 2. Poly(ethylene glycol) diglycidyl ether (54 mg, 0.1 mmol) was added into Sample 1 and Sample 2 vials, respectively. After mixing, the Sample 1 and Sample 2 vials were capped and placed at room temperature and at 50° C., respectively, for 48 hrs. Control vial was used as control example without addition of poly(ethylene glycol) diglycidyl ether.

vii) Procedure for NIPU Functionalization with Hexafluorobutyl Acrylate

SUBC-TETA polymer (R-6, 200 mg, 0.43 mmol based on mole of TETA) was dissolved in DMF (0.5 mL) followed by addition of 2,2,3,4,4,4-hexafluorobutyl acrylate (200 mg, 0.86 mmol) in a reaction vial. A drop of mesitylene was added as internal reference for NMR analysis. The reaction mixture was stirred at 60° C. for 24 hrs. After cooling to room temperature, the reaction mixture was added into diethyl ether to precipitate the polymer. The precipitated polymer SUBC-TETA—HF (R-6-F) was washed with diethyl ether for 3 times and dried under vacuum at 60° C.

viii) Procedure for Contact Angle Measurement

R-6 and R-6-F solutions were prepared by dissolving polymer (40 mg) in DMF (0.25 mL). The polymer solution was dropped onto a pre-cleaned glass slide. After drop-casting, the glass slides were placed at room temperature for 2 hours and subsequently dried at 60° C. for 24 hours. The contact angles of water droplet on the R-6 and R-6-F coated glass slides were measured.

It will be appreciated by a person skilled in the art that other variations and/or modifications may be made to the embodiments disclosed herein without departing from the spirit or scope of the disclosure as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A polymer or derivative thereof comprising a plurality of active amine groups in the backbone, wherein the polymer is a reaction product of a reaction between one or more bis-carbonates and one or more amine compounds having at least two terminal amino groups.

2. The polymer or derivative thereof of claim 1, wherein the polymer is a bio-based polymer and at least one of the bis-carbonates and/or at least one of the amine compounds having at least two terminal amino groups is derived from a bio-based source.

3. The polymer or derivative thereof of claim 2, wherein the content of the polymer derived from a bio-based source ranges from 30% to 90% by weight of the polymer.

4. The polymer or derivative thereof of claim 1, wherein the plurality of active amine groups comprise a plurality of different amine functionalities.

5. The polymer or derivative thereof of claim 1, wherein the one or more amine compounds having at least two terminal amino groups are represented by general formula (1) and the one or more bis-carbonates are represented by general formula (2): 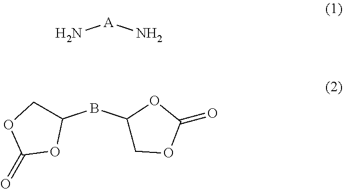
and wherein
A comprises a linear aliphatic, branched aliphatic, cyclic and/or aromatic hydrocarbons comprising at least one active amine group; and
B comprises a linear aliphatic, branched aliphatic, cyclic and/or aromatic hydrocarbons that optionally comprises at least one of an ether, amine, ester and combinations thereof.

6. The polymer or derivative thereof of claim 1, wherein the polymer comprises one or more structural units represented by general formula (3), one or more structural units represented by general formula (4): 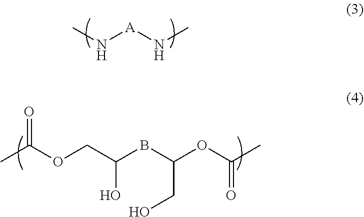
wherein
A comprises a linear aliphatic, branched aliphatic, cyclic and/or aromatic hydrocarbons comprising at least one active amine group; and
B comprises a linear aliphatic, branched aliphatic, cyclic and/or aromatic hydrocarbons that optionally comprises at least one of an ether, amine, ester or combinations thereof.

7. The polymer or derivative thereof of claim 1, wherein the structural units represented by general formula (3) are linked to structural units represented by general formula (4) via carbamate/urethane linkages.

8. The polymer or derivative thereof of claim 1, wherein A is selected from the following general formula (5), (6), (7) or (8): 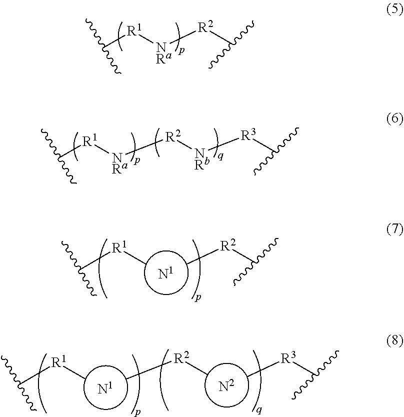
wherein
R¹, R² and R³ are each independently selected from a single bond, optionally substituted alkyl, optionally substituted alkenyl, optionally substituted alkynyl, optionally substituted cycloalkyl or optionally substituted cycloalkenyl;
R^{a} and R^{b} are each independently selected from the group consisting of H, optionally substituted alkyl, optionally substituted alkenyl and optionally substituted alkynyl;
ring N¹ and N² are each independently an optionally substituted 5-membered or 6-membered nitrogen-containing cyclic ring;
p≥1; and q≥0.

9. The polymer or derivative thereof of claim 8, wherein ring N¹ and N² are each independently selected from the group consisting of 3-pyrroline, 2-pyrroline, 2H-pyrrole, 1H-pyrrole, 2-pyrazoline, 2-imidazoline, pyrazole, imidazole, 1,2,4-triazole, 1,2,3-triazole, oxazole, isoxazole, isothiazole, thiazole, 1,2,5-oxadiazole, 1,2,3-oxadizole, 1,3,4-thiadiazole, 1,2,5-thiadiazole, diphenylamine, pyridine, pyridazine, pyrimidine, pyrazine, 1,2,4-triazine, 1,3,5-triazine, oxazine, thiazine, pyrazolidine, imidazolidine, piperidine, N-methylpiperidine, N-phenylpiperidine, pyrrolidine, piperazine, morpholine, thiomorpholine, 1,4-diazepane, quinoline, acridine and combinations thereof.

10. The polymer or derivative thereof of claim 1, wherein B is selected from the following general formula (9), (10) or (11): 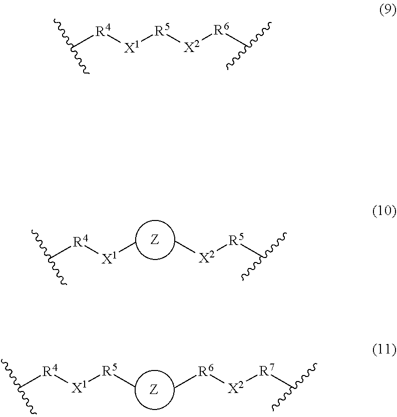
wherein
R⁴, R⁵, R⁶ and R⁷ are each independently selected from a single bond, optionally substituted alkyl, optionally substituted alkenyl, optionally substituted alkynyl, optionally substituted cycloalkyl or optionally substituted cycloalkenyl;
X¹ and X² are each independently selected from the group consisting of a single bond, —O—, —NR^{c}—, —C(═O)—O— and —O—C(═O)—, wherein R^{c} is selected from the group consisting of H, optionally substituted alkyl, optionally substituted alkenyl and optionally substituted alkynyl; and
ring Z is an optionally substituted 5-membered or 6-membered hydrocarbon cyclic ring or an optionally substituted 5-membered or 6-membered heterocyclic ring having up to three heteroatoms independently selected from the group consisting of O, N, S and NH.

11. The polymer or derivative thereof of claim 8, wherein R¹ to R⁷ are each independently selected from a single bond, optionally substituted C₁-C₂₀ alkyl, C₁-C₂₀ optionally substituted alkenyl, C₁-C₂₀ optionally substituted alkynyl, C₁-C₂₀ optionally substituted cycloalkyl and C₁-C₂₀ optionally substituted cycloalkenyl; and R^{a} and R^{b} are each independently selected from the group consisting of H, optionally substituted C₁-C₂₀ alkyl, optionally substituted C₁-C₂₀ alkenyl and optionally substituted C₁-C₂₀ alkynyl.

12. The polymer or derivative thereof of claim 1, wherein the one or more amine compounds having at least two terminal amino groups are selected from the group consisting of diethylenetriamine (DETA), diamino-N-methyldiethylamine (DMA), triethylenetetramine (TETA), diamino-N-methyldipropylamine (DMPA), pentaethylenehexamine (PEHA), bis(3-aminopropyl)piperazine (BAP), spermine, spermidine, lysine salt (LyS) and diaminopentane (DAP); and/or
the one or more bis-carbonates are selected from the group consisting of succinic bis-carbonate (SuBC), adipic bis-carbonate (ABC), butanediol bis-carbonate (BBC), isomers of pyridine bis-carbonate (PBC1), (PBC2), (PBC3), (PBC4), (PBC5) and/or (PBC6):

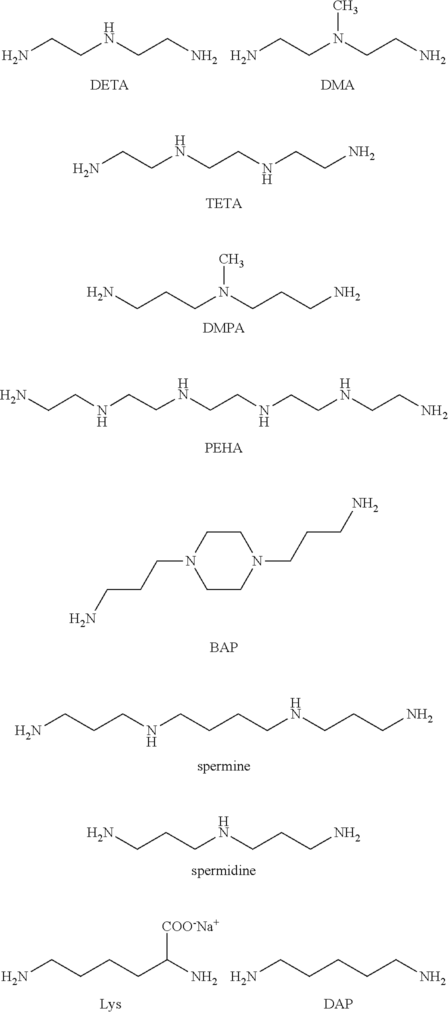

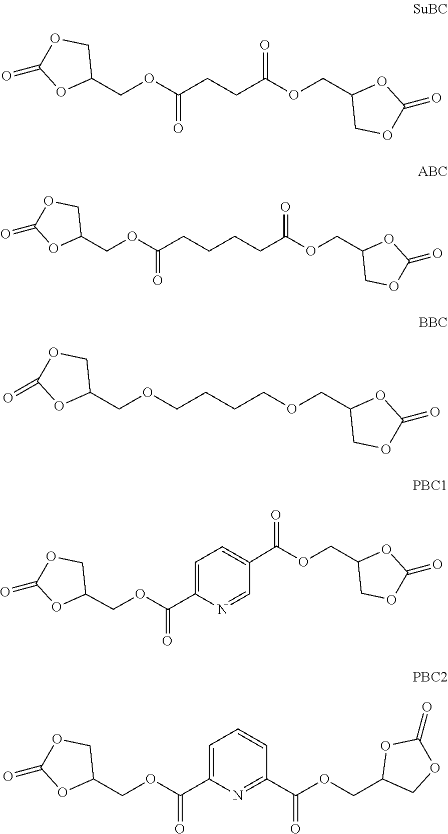 [SMILES: O=C(CCC(=O)OCC1COC(=O)O1)OCC1COC(=O)O1 ; O=C(CCCCC(=O)OCC1COC(=O)O1)OCC1COC(=O)O1 ; O=C1OCC(COCCCCOCC2COC(=O)O2)O1 ; O=C1OCC(COC(=O)c2ccc(C(=O)OCC3COC(=O)O3)nc2)O1 ; O=C1OCC(COC(=O)c2cccc(C(=O)OCC3COC(=O)O3)n2)O1]

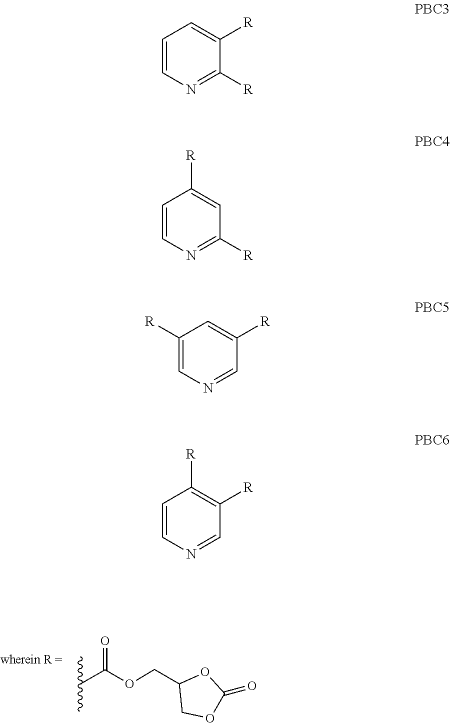

13. (canceled)

14. The polymer or derivative of claim 1 selected from the following: 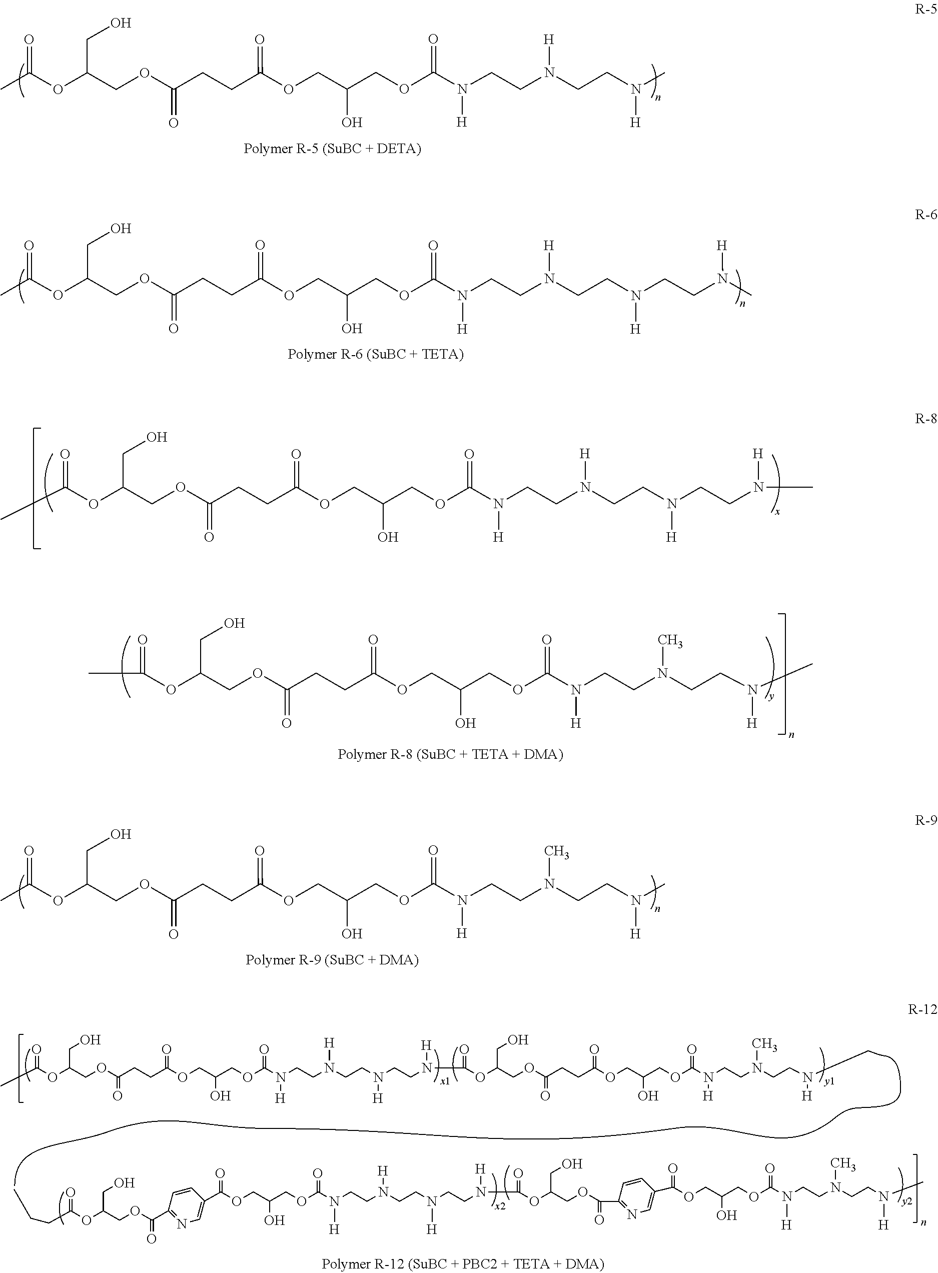 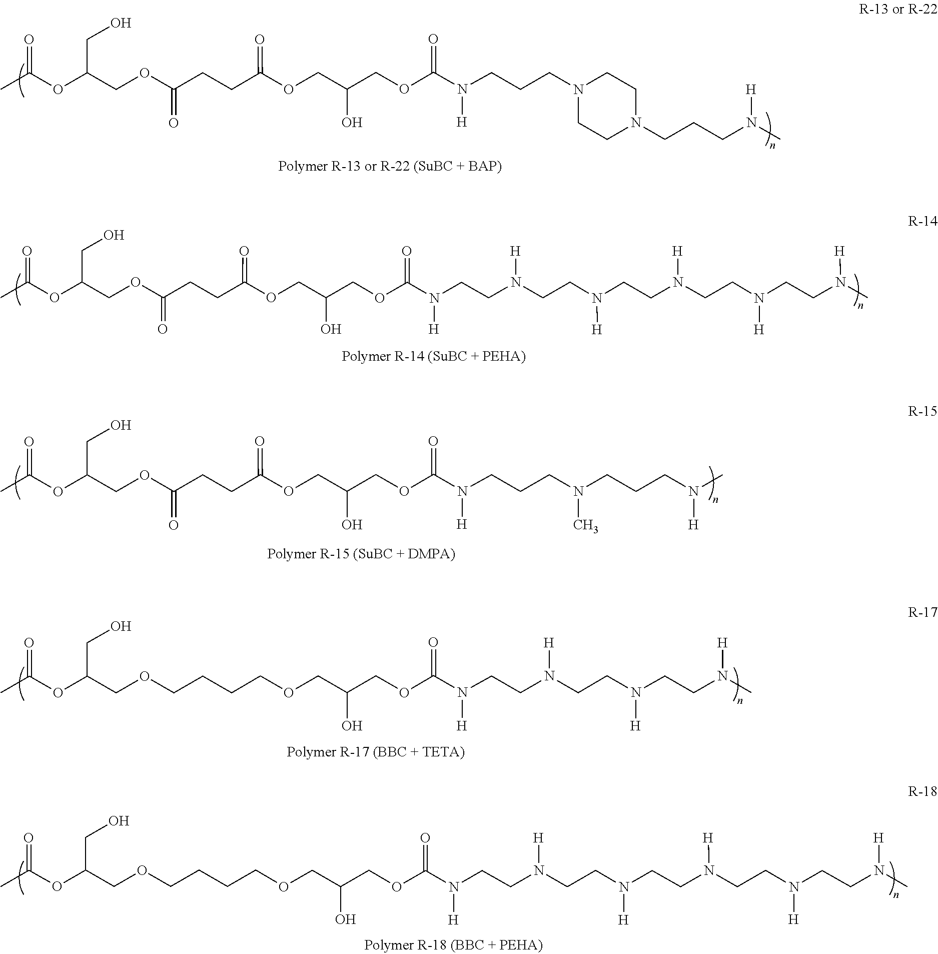 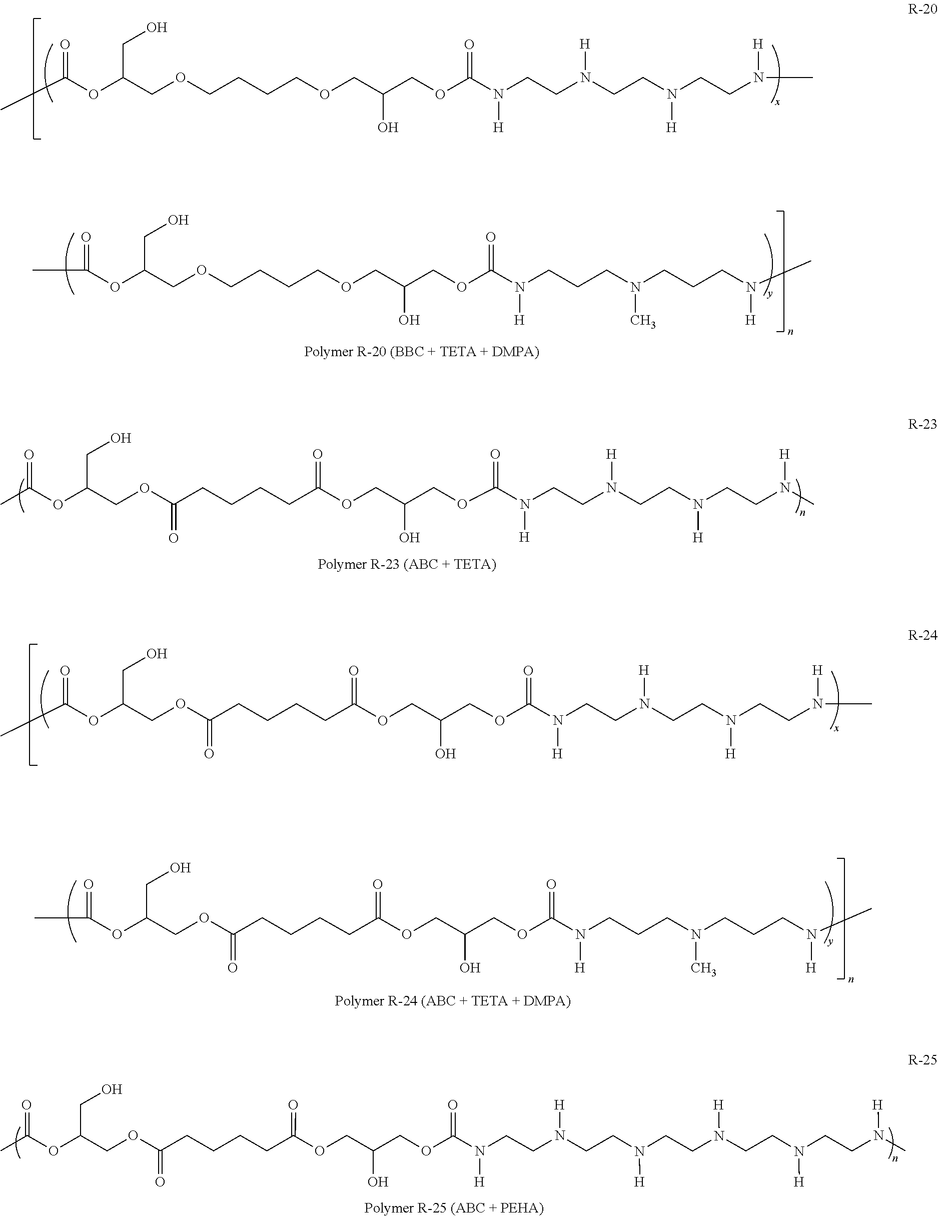
optionally wherein the polymer or derivative thereof has one or more of the following properties: water-soluble: hydrolysable; biodegradable; and biocompatible.

15. The polymer or derivative thereof of claim 1, wherein the polymer or derivative thereof further comprises at least one of a hydroxyl group and an active amine group originally present in the polymer that has been functionalized.

16. The polymer or derivative thereof of claim 1, wherein the polymer or derivative thereof is a grafted polymer obtained by grafting the polymer on a substrate or another polymer.

17. (canceled)

18. Use of the polymer or derivative thereof of claim 1, as an anti-redepositioning agent, an anti-bacterial agent, an adhesive, an adhesion promoter, a fiber modifier, a pigment dispersant, a chelating agent, a flocculating agent, a wet strength improving additive, a pour point depressant, or a carbon dioxide capture agent.

19. A method of preparing the polymer of claim 1, or a derivative thereof, the method comprising: polymerizing one or more diamines represented by general formula (1) with one or more biscarbonates represented by general formula (2) to obtain the polymer: 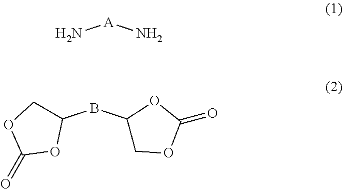
wherein
A comprises a linear aliphatic, branched aliphatic, cyclic and/or aromatic hydrocarbons comprising at least one active amine group; and
B comprises a linear aliphatic, branched aliphatic, cyclic and/or aromatic hydrocarbons that optionally comprises at least one of an ether, amine, ester and combinations thereof.

20. The method of claim 19, wherein the method comprises a) mixing one or more diamines represented by general formula (1) with one or more biscarbonates represented by general formula (2) to obtain a reaction mixture; and b) precipitating the polymer.

21. The method of claim 19, wherein the method further comprises a step of functionalising at least one of a hydroxyl group and an active amine group present in the polymer.

22. The method of claim 19, wherein the method further comprises a step of grafting to at least one of a hydroxyl group and an active amine group present in the polymer to another polymer or substrate.
